(19) United States
(12) Patent Application Publication
(10) Pub. No.: US 2012/0097599 A1
(43) Pub. Date: Apr. 26, 2012

(54) ELECTROKINETIC BELT PRESS APPARATUS AND A BELT THEREFOR

(76) Inventors: Colin John Francis Philip Jones, York (GB); John Lamont-Black, Newcastle upon Tyne (GB)

(21) Appl. No.: 13/379,514

(22) PCT Filed: Jun. 21, 2010
(86) PCT No.: PCT/GB10/51017

§ 371 Date: Dec. 20, 2011

(30) Foreign Application Priority Data
Jun. 29, 2009 (GB) 0911198.0
Jun. 29, 2009 (GB) 0911199.8

(51) Int. Cl. B01D 33/04

(52) U.S. Cl. 210/400

(57) ABSTRACT

A belt (10) for an electrokinetic belt press (100) comprises a woven material, and having an electrical transfer zone (18) extending longitudinally along the belt (10) between a filtration zone (12) and an edge (22) of the belt (10), the electrical transfer zone (18) comprising a plurality of electrically-conducting warp elements arranged as a plurality of substantially parallel stripes (26), wherein adjacent stripes (26) are separated from each other in the transverse direction by at least one electrically-insulating warp element (28). The stripes (26) may be discontinuous in order to electrically isolate discrete conducting zones (14) of the filtration zone (14), the discontinuities being displaced longitudinally from each other. Also, an electrokinetic belt press apparatus (100) is described, comprising a pair of filtration belts (110, 111), at least one of which comprises a plurality of discrete conducting areas (14). A plurality of independent power supplies (P1-P6) are connected between contact elements (120, 121) for contacting the filtration belts (110, 111). The apparatus (100) further includes means (240, 250, 251) for applying a reverse polarity to one of the belts to de-cake the belt, and means (260, 270, 280, 290) for recirculating filtrate from the distal end (190) of a dewatering section (170) of the apparatus to the proximal end (180).

### FIELD OF THE INVENTION

The present invention relates to a belt for an electrokinetic belt press apparatus, and an electrokinetic belt press apparatus, for removing liquid from a material comprising a mixture of solid particles and liquid.

### BACKGROUND OF THE INVENTION

Many industrial fields require the removal of water form particulate suspensions such as sludges, for a range of reasons. For example, particulate suspensions are often the by-product of wastewater treatment and industrial processes such as mining or drilling. Disposal of the waste material can be problematic due to the large volumes often generated, requiring the corresponding volume either on the surface or below ground for the disposal. Moreover, there is also a danger caused by their deposition: large quantities of sludge can be dangerous as they can appear on the surface to be solid, but may be unable to take the weight of a person trying to traverse across the waste. These problems can be ameliorated by removal of the water to reduce the volume and to increase the density and flowability of the deposit.

One apparatus well known in the art for removing water from sludge is often referred to as a belt press. In this apparatus, the sludge is compressed between two moving belts, at least one of which is porous to water, allowing water to be squeezed from the sludge through the porous belt to a drain. In order to increase the speed of dewatering, the sludge may be subjected to an electric potential, so that one belt functions as an anode and the other belt as a cathode. To facilitate application of the potential to the sludge, the electrodes required may be incorporated into at least one and ideally both of the belts, thus forming what is often referred to as an electrokinetic belt.

In a belt filter press, such belts are generally used in pairs, operating together as a pair of filtration electrodes. In addition to the hydraulic dewatering force of the belt press, the electric potential provides an additional dewatering force acting on the water to drive it out of the sludge, thereby increasing the overall rate of dewatering.

The difficulties in manufacturing and operating such belts are manifold. For example, care needs to be taken to achieve and maintain electrical contact between the belts and the generator of the electric potential, for example by means of brushes. In particular, sufficiently good contact needs to be maintained in the presence of a sludge material. On the other hand, contact brushes should not wear out at too high a rate as this would increase costs.

WO 2005/033024 discloses an apparatus including two sheets of water permeable materials configured to run as parallel belts sandwiching the sludge, the belts including electrodes woven into the belt material. Application of a voltage between the electrodes causes water to flow out of the sludge, through the belt and away to drain.

US 2003/150789 discloses a belt press in which an electromotive force is transmitted via sections of metallic mesh inserted into the conveyer belt.

However, the prior art methods and apparatus suffer from a number of drawbacks. Firstly, some apparatuses can, due to the differing resistivity of dewatered sludge give rise to increased currents at different regions of the apparatus. Often the current can reach more than 450 A compared with the more normal 200 A. This increased current can cause extra demands to be placed on elements of the apparatus, such as electrodes, brushes and cabling, with the result that the efficiency, in terms of volume of water removed per unit energy passed, is reduced, along with the life-time of these parts. It is therefore important that a potential applied to one portion of the belt is confined within a localised region of the belt. However, providing discrete conducting regions on the belts introduces the further difficulties of providing electrical connections to the various conducting zones, and isolating the conducting regions from each other, whilst also ensuring structural mechanical integrity.

Yet another problem associated with a prior art apparatus having two belts moving relative to one another is drift in the longitudinal direction of one of the belts relative to the other. This can lead to less than optimum overlap of elements of the belt, particularly if the belts comprise discrete conducting zones.

A yet further problem which can occur, particularly with certain sludges is precipitation of minerals such as struvite: an effect which is increased at higher pHs. Such precipitates, if allowed to build up, reduce the effective surface area of the belt and therefore its overall performance. The problem is especially acute in respect of a cathode belt. The precipitates can be removed by treating the belts with an acid, such as 10% w/w sulphuric acid. However, this causes its own handling difficulties and can lead to accelerated corrosion of some component parts.

The belt and apparatus of the present invention seek to address the above problems and to improve the performance of the dewatering process and apparatus.

### SUMMARY OF THE INVENTION

According to a first aspect of the invention, there is provided a belt for an electrokinetic belt press apparatus for removing liquid from a material comprising a mixture of solid particles and liquid, the belt comprising:

woven material including a plurality of warp elements substantially parallel to the longitudinal direction of the belt, and a plurality of weft elements transverse to the longitudinal direction of the belt;

a filtration zone extending longitudinally along the belt, wherein one or more weft elements of the filtration zone are electrically-conducting; and

an electrical transfer zone extending longitudinally along the belt between the filtration zone and a first edge of the belt, and comprising a plurality of electrically-conducting warp elements, wherein the or a plurality of said electrically-conducting weft elements is in electrical contact with at least one electrically-conducting warp element of the electrical transfer zone;

wherein the plurality of electrically-conducting warp elements of the electrical transfer zone are arranged as a plurality of substantially parallel stripes, each stripe comprising at least one electrically-conducting warp element, wherein adjacent stripes are separated from each other in the transverse direction by at least one electrically-insulating warp element.

By providing an electrical transfer zone comprising a plurality of substantially parallel stripes, rather than as a single stripe or band, the overall stiffness of the electrical transfer zone is reduced so that there is a manageable differential strain between the filtration zone of the belt and electrical transfer zone.

The warp elements of the filtration zone may be electrically-insulating.

The filtration zone may comprise a plurality of conducting zones and non-conducting zones, alternately arranged along the length of the belt, wherein at least one weft element in each conducting zone is electrically-conducting.

Advantageously, when electrically-insulating warp elements are used in the filtration zone, it is possible to create discrete conducting zones along the length of the belt without any mechanical interruptions or discontinuities in the warp and weft elements of the filtration zone. The belt can be woven in a single weaving step, which reduces the complexity and cost of manufacturing the belt, and produces a strong structure.

Each electrically-conducting stripe of the electrical transfer zone may be longitudinally discontinuous, each discontinuity being located adjacent a non-conducting zone of the filtration zone.

By providing discontinuities in each electrically-conducting stripe of the electrical transfer zone, it is possible to electrically isolate one or more conducting zones from another conducting zone or zones. By locating these discontinuities adjacent a non-conducting zone of the filtration zone, the weft elements of which are non-conducting, the mechanical integrity of the belt is maintained since the conducting zones can be isolated from each other without any interruption of the weft elements. The continuity of the non-conducting weft elements assists in mechanically stabilising the belt around the discontinuities of the electrically conducting stripes of the electrical transfer zone.

In addition, the presence of the electrically-insulating warp element separating adjacent electrically-conducing stripes of the electrical transfer zone provides a further advantage when used in combination with discontinuities in the conducting warps, because the electrically-insulating warp elements of the electrical transfer zone may be continuous or substantially continuous along the length of the belt, thereby improving the mechanical integrity of the belt in the vicinity of the discontinuities.

Furthermore, the continuous non-conducting warp elements of the electrical transfer zone help to provide an effectively continuous and smooth surface for electrical transfer to the belt.

The discontinuities in neighbouring electrically-conducting stripes of the electrical transfer zone may be longitudinally displaced from each other.

By longitudinally displacing the discontinuities or breaks in neighbouring electrically-conducting stripes, the discontinuities do not line up across the width of the electrical transfer zone so as to create a zone of preferential weakness, which might otherwise lead to critical failure of the mechanical integrity of the belt. Longitudinal displacement of the discontinuities in neighbouring electrically-conducting stripes minimises concentrations of stress and thus helps to avoid unacceptable strain or even rupture of the woven structure.

Importantly, it is possible to distribute the breaks in this manner while still achieving an electrical discontinuity in the electrical transfer zone as a whole, because the electrically-conducting stripes of the electrical transfer zone are electrically isolated from each other in the vicinity of the discontinuities by the non-conducting, electrically-insulating warp elements.

The discontinuities may be arranges in an echelon, V-shaped, zig-zig or saw-tooth pattern.

Advantageously, this type of pattern helps to minimise the overall length of the non-conductive zone necessary to accommodate the longitudinally displaced or staggered discontinuities in the stripes of the electrical transfer zone, thereby maximising the proportion of the filtration zone which can be occupied by conducting zones.

The ends of the belt may be joined by a seam traversing a non-conducting zone.

The seam joining the ends of the belt is generally known as a clipper seam, and is often implemented using metal staples. Locating this seam in a non-conducting zone prevents large currents, which can occur in the electrical transfer zone, from flowing across and possibly melting the clipper seam.

In a preferred embodiment, a plurality of said electrically-conducting warp elements of the electrical transfer zone have a diameter larger than the diameter of the or each electrically-insulating warp element of the electrical transfer zone.

Advantageously, the larger diameter of the conducting warp elements makes them stand proud of the insulating warp elements, for improved contact with transfer brushes connected to a power supply.

In one embodiment, the electrically-conducting warp elements of the electrical transfer zone comprise multi-filament threads.

Advantageously, the use of multifilament threads, for example multifilament wires, results in a smoother contact surface.

At least a part of the electrical transfer zone may be impregnated with a synthetic resin.

Advantageously, this acts to further stabilise the belt mechanically, in particular by filling any gaps left by discontinuities in the conducting stripes of the electrical transfer zone and by increasing friction in the weave. A further advantage is that corrosion of the electrically-conducting warp elements of the electrical transfer zone is reduced, since they are isolated from the material being dewatered and therefore cannot discharge electricity directly into the material being dewatered. Yet another advantage is that the contact points between the electrically-conducting warp elements of the electrical transfer zone and the conducting weft elements are kept free of water, which reduces corrosion and maintains good electrical contact.

Preferably, the woven material of the electrical transfer zone of the belt is smoother on a first surface of the belt than on a second, opposite surface, wherein said first surface is adapted to contact terminals of an electrical power supply.

The smoother surface improves electrical connection to the power supply and reduces wear on the contact elements or brushes.

Preferably, the woven material of the filtration zone of the belt is smoother on the second surface of the belt than on the first surface, wherein said second surface is adapted to contact the material to be dewatered.

Advantageously, a smoother surface in contact with the material to be dewatered improves cake discharge from the belt. By providing the smooth side of the filtration zone and the smooth side of the electrical transfer zone on opposite surfaces of the belt, for example by the reversing the weave pattern between the filtration zone and the electrical transfer zone, the advantages of improved electrical contact and improved cake discharge can be achieved simultaneously.

Preferably, the belt further comprises an electrical network zone extending longitudinally along the belt and located between the filtration zone and a second edge of the belt, wherein one or more warp elements of the electrical network zone are electrically conducting.

Advantageously, the electrical network zone can provide additional electrical connectivity between the weft electrodes of a conducting zone, so that corrosion leading to a break in a weft electrode does not necessarily disconnect a portion of the electrode from the power supply. Further, this improves voltage distribution across charged conductive zones.

In one embodiment, at least a portion of the woven material is heat-set.

Heat-setting the woven material of the belt increase the friction between the warp and weft elements, further improving the mechanical stability of the belt, and can be used for example to stabilise the areas around the discontinuities in the electrical transfer zone.

According to a second aspect of the invention, there is provided a belt for an electrokinetic belt press apparatus for removing liquid from a material comprising a mixture of solid particles and liquid, the belt comprising:

woven material including a plurality of warp elements substantially parallel to the longitudinal direction of the belt, and a plurality of weft elements transverse to the longitudinal direction of the belt; and

a filtration zone extending longitudinally along the belt;

wherein at least one weft element of the filtration zone is electrically-conducting, and

wherein the warp elements of the filtration zone are electrically-insulating.

Advantageously, this helps to prevent shorting between two belts of this type when used in an electrokinetic belt press. The electrically-insulating warp elements effectively enclose the weft elements in a cage-like structure, so that if the two belts come into contact with each other, the weft electrodes of the conducting zones of the belts are prevented from contacting each other.

Furthermore, this feature has the effect that, in the filtration zone of the belt, current is only discharged from the electrically-conducting weft elements (referred to as weft electrodes), since the warp elements are non-conducting. This means that there will be no corrosion associated with the warps, which would otherwise lead to significant weakening of the belt as the warp elements lie parallel to the axis of tensioning when in use on a belt press. If corrosion of the conducting weft elements occurs, the warp elements remain intact and continue to crimp and stabilise the weft elements. Thus the corrosion has a minimal effect on the integrity of the belt because the weft elements are not required to resist such high stress in use.

By confining the electrode function of the filtration zone to weft elements only, the corrosion rate of the electrodes is reduced. This is because the weft elements (and thus the weft electrodes) lie parallel to the axis of tension in a belt press, whereas it is known that corrosion occurs at an accelerated rate where conducting threads are under mechanical stress, especially tensile stress.

Similarly, by confining the electrode function of the filtration zone to weft elements only, the rate of fatigue or micro crack propagation within the electrode elements. This is because, unlike the warp elements, the weft elements are not constantly flexed around the rollers of a belt press in use.

The filtration zone may comprise a plurality of conducting zones and non-conducting zones, alternately arranged along the length of the belt, wherein at least one weft element in each conducting zone is electrically-conducting.

Advantageously, it is possible to create discrete conducting zones along the length of the belt without any mechanical interruptions or discontinuities in the warp and weft elements of the filtration zone, since the warp elements of the filtration zone are non-conducting. The belt can be woven in a single weaving step, which reduces the complexity and cost of manufacturing the belt, and produces a strong structure.

A plurality of the electrically-insulating warp elements of the filtration zone may have a smaller diameter than the conducting weft elements of the filtration zone.

Advantageously, this results in the warp elements curving over and under the weft elements which remain comparatively straight in the woven material. Thereby the warp elements crimp around the weft elements, holding the wefts in place. Increasing the diameter of the conducting weft elements also increases the service lifetime of the belt as the weft electrodes last longer. Since the belt is not required to flex in the transverse direction, increasing the diameter of the conducting weft elements does not adversely affect belt flexibility.

At least a portion of the woven material may be heat-set.

Advantageously, this further helps to hold the warp and weft elements of the woven material in place, and can further enhance the crimping effect of the warp elements around the weft elements.

The ratio of the conducting weft element frequency to the weft element frequency in at least one said conducting zone may be in the range 1:1 to 1:5. More preferably, this ratio may be in the range 1:1 to 1:3.

According to a third aspect of the invention, there is provided a belt for an electrokinetic belt press apparatus for removing liquid from a material comprising a mixture of solid particles and liquid, the belt comprising:

woven material including of a plurality of warp elements substantially parallel to the longitudinal direction of the belt, and a plurality of weft elements transverse to the longitudinal direction of the belt;

a filtration zone extending longitudinally along the belt, wherein one or more weft elements of the filtration zone is electrically-conducting; and

an electrical transfer zone extending longitudinally along the belt between the filtration zone and a first edge of the belt, and comprising a plurality of electrically-conducting warp elements, wherein one or more of said electrically-conducting weft elements are in electrical contact with at least one electrically-conducting warp element of the electrical transfer zone;

wherein the woven material of the electrical transfer zone of the belt is smoother on a first surface of the belt than on a second, opposite surface, wherein said first surface is adapted to contact terminals of an electrical power supply.

The smoother surface of the electrical transfer zone and the smoother surface of the filtration zone may be on opposite surfaces of the belt.

The woven material in the filtration zone of the belt may be smoother on the second surface of the belt than on the first surface, wherein said second surface is adapted to contacting the material to be dewatered.

According to a fourth aspect of the present invention, there is provided an electrokinetic belt press for removing liquid from a material comprising a mixture of solid particles and liquid, comprising a belt according to the first, second or third aspects of the invention as defined above.

According to a fifth aspect of the present invention, there is provided an electrokinetic belt press apparatus for removing liquid from a material comprising a mixture of solid particles and liquid, the apparatus comprising

a first filtration belt comprising a plurality of discrete, longitudinally-separated electrically-conducting zones, and a second filtration belt comprising one or more electrically-conducting zones;

a plurality of first contact elements, arranged to movably contact the first filtration belt;

one or more second contact elements, arranged to movably contact the second filtration belt; and

a plurality of power supplies, having independently determined output voltages;

wherein a plurality of said power supplies are connected between a respective first contact element and one of the or each second contact elements, such that, in use, a plurality of said conducting zones of the first filtration belt each function as a respective one of an anode and a cathode when in electrical contact with one of the plurality of first contact elements, and the or a plurality of conducting zones of the second filtration belt each function as a respective other one of an anode and a cathode when in electrical contact with one of the or each second contact elements.

By providing a plurality of independently controllable power supplies, in combination with a plurality of discrete conducting zones or areas on the first belt, it is possible to apply different potentials between the two belts at different locations. Thus the potential applied to the material to be dewatered can be adjusted as the material is conveyed through the belt press apparatus in order to take into account the changing resistivity of the material as it is dewatered. Advantageously, this prevents current from building up between certain locations of the belts, for example where the material to be dewatered is wettest, which would otherwise divert electrical energy away from the regions in which the electrokinetic treatment has greatest effect. Furthermore, corrosion in the conducting zones of the belts is reduced due to prevention of excessive currents, thereby increasing the lifetime of the belts.

A spacing between neighbouring first contact elements may be equal to or less than a length of the electrically-conducting zones of the first belt in the longitudinal direction.

In one embodiment the belt press apparatus further comprises a plurality of second contact elements, wherein a plurality of said power supplies are connected between a respective first contact element and a respective second contact element.

The second belt may comprise a plurality of discrete, longitudinally-separated electrically-conducting zones, and wherein a spacing between neighbouring second contact elements is equal to or less than a spacing between the discrete electrically-conducting zones of the second belt.

The plurality of second contact elements may be electrically connected via a bus.

Advantageously, this enables the multiple conducting zones of the first belt to discharge electricity constantly, regardless of their position relative to the conducting zones of the second belt, which may vary due to relative belt drift in the longitudinal direction of the belts. The bus (for example a bulbar) permits multiple complex and time variant pathways for current to pass through the sludge via the belts and to maintain an even current density in a dynamic environment and reduces the chance of build up of an excessively high current in any particular region.

In one embodiment, a plurality of said first contact elements are arranged to movably contact the first filtration belt adjacent a first edge, and a plurality of said second contact elements are arranged to movably contact the second filtration belt adjacent an edge opposing a second edge of the first filtration belt.

Advantageously, this helps to maintain an even electric field across the width of the belts, and further helps to prevent shorting between the belts by avoiding contact of the portions contacted by the contact elements.

In one embodiment, the belt press apparatus comprises a plurality of rollers for conveying the first and second filtration belts through the dewatering section,

wherein said first and second contact elements are arranged to contact the first and second filtration belts adjacent alternate rollers.

Advantageously, this helps to maintain a more uniform electric field along the length of the belts between adjacent contact elements, and also provides a particularly compact arrangement.

The rollers may be arranged in two rows, the first contact elements being arranged adjacent the rollers of a first row, and the second contact elements being arranged adjacent the rollers of a second row.

Advantageously, this provides a more compact apparatus and facilitates access for electrical contact with the belts.

According to a sixth aspect of the invention, there is provided an electrokinetic belt press apparatus for removing liquid from a material comprising a mixture of solid particles and liquid, the apparatus comprising:

a first filtration belt and a second filtration belt, each belt comprising:
woven material including of a plurality of warp elements substantially parallel to the longitudinal direction of the belt, and a plurality of weft elements transverse to the longitudinal direction of the belt,
a filtration zone extending longitudinally along the belt, wherein one or more weft elements of the filtration zone is electrically-conducting, and
an electrical transfer zone extending longitudinally along the belt between the filtration zone and a first edge of the belt, and comprising one or more electrically-conducting warp elements, wherein at least one said electrically-conducting weft element is in electrical contact with at least one electrically-conducting warp element of the electrical transfer zone;

at least one first contact element, arranged to movably contact the electrical transfer zone of the first filtration belt;

at least one second contact element, arranged to movably contact the electrical transfer zone of the second filtration belt;

at least one power supply, connected between said first and second contact elements such that, in use, electrically-conducting areas of the first and second belts function as an anode and a cathode respectively, when in electrical contact with said first and second contact elements respectively; and

a dewatering section in which, in use, said material is sandwiched between portions of the first and second filtration belts;

wherein the first and second filtration belts are arranged such that, in the dewatering section, the first edge of the first filtration belt opposes a second edge of the second filtration belt, and the first edge of the second filtration belt opposes a second edge of the first filtration belt.

Arranging the belts so that their electrical transfer zones are on opposite sides, advantageously helps to maintain an even electric field across the width of the belts, because this arrangement tends to cancel out the gradual voltage drop which occurs across each belt from the electrical transfer zone to the opposite edge. This feature also helps to prevent electrical shorting between the belts, as the exposed electrical transfer zones are kept apart from each other.

The electrokinetic belt press apparatus may further comprising a plurality of rollers for conveying the first and second filtration belts through the dewatering section, wherein said first and second contact elements are arranged to contact the first and second filtration belts adjacent alternate rollers.

The rollers may be arranged in two rows, the first contact elements being arranged adjacent the rollers of a first row, and the second contact elements being arranged adjacent the rollers of a second row.

According to a seventh aspect of the present invention, there is provided an electrokinetic belt press apparatus for removing liquid from a material comprising a mixture of solid particles and liquid, the apparatus comprising

a first filtration belt comprising a plurality of discrete, longitudinally-separated electrically-conducting areas, and

a second filtration belt comprising one or more electrically-conducting areas;

a dewatering section in which, in use, said material is sandwiched between the two belts, and

at least one power supply for applying a potential difference between at least one conducting area of the first belt and at least one conducting area of the second belt in said dewatering section such that said conducting areas function as cathode and anode respectively,

wherein the apparatus further comprises potential application means for applying a reverse-polarity potential to a conducting area of the first filtration belt in a cleaning section of the apparatus, such that said conducting area functions as an anode.

Advantageously, this reduces the build-up of precipitates on the belt. By providing a localised section of reverse polarity, the belt press apparatus can operate continuously, dewatering material in the dewatering section at the same time as de-scaling a portion of the belt traversing the cleaning section of the apparatus. Since the entire belt is conveyed through the cleaning section, this provides regular cleaning of the entire conducting area of the belt and thus reduces the build-up of chemical precipitates.

In one embodiment, the electrokinetic belt press apparatus further comprises a support element for supporting the first filtration belt in said cleaning section, wherein said support element includes an electrically-insulated conductor adapted to function as a cathode.

By locating the cathode of the cleaning section in a support element of the apparatus, the second belt is not required as an electrode in the cleaning section, and thus the cleaning section may, for example, be located in a part of the apparatus traversed by only the first belt. Advantageously, this maximises the length of the dewatering section, in which the two belts are necessarily close together to function as opposite polarity electrodes for applying a potential difference across the material sandwiched between them.

According to an eighth aspect of the present invention, there is provided an electrokinetic belt press apparatus for removing liquid from a material comprising a mixture of solid particles and liquid, the apparatus comprising:

first and second filtration belts;

a dewatering section, in which, in use, said material is sandwiched between portions of the first and second filtration belts; and

a filtrate recirculator for collecting filtrate from the distal portion of the dewatering section and reintroducing the collected filtrate to the material to be dewatered at a proximal portion of the dewatering section.

Advantageously, the high concentration of hydroxide ions in the filtrate collected from the distal portion of the dewatering section improves dewatering efficiency at the distal end of the dewatering section, by helping to maintain a high coefficient of electro-osmotic permeability, breaking down cell wall material in the sludge. In addition, it buffers acid production adjacent the anode elements of the belt thus reducing corrosion.

According to another aspect of the invention, there is provided a belt electrode for use in an electrokinetic belt press, to remove water from an aqueous suspension of particulate material, the belt comprising a woven material having a plurality of warp elements comprising warp threads or strips orientated along the length of the belt and weft elements comprising weft threads across the width of the belt only, one or more of the weft threads comprising an electrically conducting material; the belt comprising conducting and non-conducting zones, alternately arranged along the length of the belt and spanning the belt, a warp transfer strip along one edge of the belt, the warp transfer strip comprising one or more electrically conducting elements in electric contact with one end of the weft threads and woven about the weft threads to retain the weft threads in position.

The feature of the weft threads lying across the belt only and not being present parallel to the length of the belt gives a longer lasting, safer and more efficient belt.

Preferably the warp threads are of smaller diameter than the weft threads. Typical values are 0.5 mm for the warp threads and 0.7 mm for the weft threads.

The warp transfer strip optionally comprises a plurality of conducting threads or strips which are further optionally separated by non-conducting threads. Yet further optionally, the thickness of the non-conducting thread is thinner than that of the conducting threads or strips: the former lying in the range of from 0.4-0.6 mm and the latter in the range of 0.5-0.8 mm. This enables the conducting warp elements to stand proud of the belt to achieve better contact with the current source of the belt press.

Preferably the material from which the or each conducting warp thread or strip is formed is selected from copper, bronze or steel: copper having a number of advantages, for example forming a protective patina under certain conditions.

The or each conducting warp thread or strip advantageously has one or more discontinuities along its length which discontinuities isolate electrically regions of a belt. The discontinuities are particularly advantageously located in a non-conducting zone to facilitate the electrical isolation. Further advantageously discontinuities in adjacent warp threads or strips in a zone are separated longitudinally from each other to minimise weakening of the woven structure.

The frequency of the weft is preferably from 1:1 to 1:5. For a cathode belt the frequency is preferably from 1:2 to 1:3 and for an anode belt from 1:1 to 1:2.

Preferably one side of the warp transfer strip is so woven as to give a smooth finish, such as a satin finish to improve contact with the current source: the smooth side is to be used for the non material bearing side. The smooth finish is further preferably achieved by reverse weaving.

The electrically conducting warp and weft elements advantageously comprise multi-filament threads which provide greater flexibility for weaving in comparison to monofilaments. Especially advantageously, the warp element comprises multi-filaments on the weft element monofilaments. The outer strip of the belt preferably consists of non-conducting warp threads.

The edges of the belt and warp transfer strip are preferably treated to render the edges less penetrable by water. Especially preferably the edge and the warp transfer strip are treated with a hydrophobic resin to repel water from the strip.

According to yet another aspect of the invention, there is provided a belt press to remove water from an aqueous particulate suspension the press including a belt as defined above.

According to yet another aspect of the invention there is provided a belt press apparatus for reducing the water contents of a particulate semi-liquid mixture the apparatus including first and second woven filtration belts permeable to the liquid, but impermeable to at least some of the solid contained in the mixture the, each filtration belt comprising conductive elements woven into the warp and the weft of the belt material such that said conductive elements are located in discrete conducting regions, the regions being axially separated from each other, the apparatus comprising a parallel zone in which the portions of each belt are constrained to move in parallel configuration and in contact with sludge material sandwiched therebetween, a plurality of DC current sources configured to form a circuit allowing current to flow through the sludge, the sources being in contact with and enabling a portion of the first belt to function as an anode and a portion of the second belt to function as a cathode, the contacts between individual circuits and the belts being axially spaced along the belt such that the distance between neighbouring contacts is greater than the axially length of a conducting zone. By this arrangement, the current is prevented from building up across certain locations within the belt.

Preferably the belts are conveyed through the parallel portions by a plurality of rollers. Further preferably the rollers are provided on at least two levels to provide space saving for the apparatus.

Advantageously anode contact of a circuit onto a belt is adjacent a roller and further advantageously a cathode contact is on the opposite side of the machine but in a position adjacent to the next neighbouring roller. Particularly advantageously the anode contacts the belt around the upper portion of the roller and the cathode around the lower portion of the roller.

Importantly, one plurality of the each and all of the independent DC current source is linked to a buss bar (also known as a busbar) which permits multiple complex and time variant pathways for current to pass through the sludge via the belts and to maintain an even current density in a dynamic environment and reduces the chance of build up of too high a current in a particular region.

In a further region of the apparatus, means is provided to subject the first and second belts to a reverse polarity to that experienced in the parallel zone, this aiding the removal and preventing build-up of unwanted deposits on the belt. In this particular region, the cathode is advantageously provided as one or more metallic elements located within a non-metallic support bar, preferably formed of nylon said bar spanning the width of the belt.

Preferably, water removed from the distal portion of the parallel zone is circulated back to sludge in the proximal part of the parallel zone. The water removed from the distal zone has a higher pH than that in the proximal zone and its addition to the upper anode belt aids in the maintenance of pH neutral conditions thus reducing rates of corrosion and reduces the rate of reduction of the coefficient of electroosmotic permeability which is common amongst numerous particulate suspensions slurries when subjected to lowered pH. Further advantageously, the water is added to the sludge in the region of one of the lower level rollers.

### BRIEF DESCRIPTION OF THE DRAWINGS

Preferred embodiments of the present invention will now be described, by way of example only and not in any limitative sense, with reference to the accompanying drawing, in which:

FIG. 1 illustrates a filtration belt according to a first embodiment of the invention;

FIG. 2 illustrates the electrical transfer zone of the filter belt shown in FIG. 1;

FIG. 3 illustrates an alternative pattern of discontinuities in the electrical transfer zone;

FIG. 4 illustrates modelled current flow in a conducting area of the filtration belt shown in FIG. 1;

FIG. 5 shows a cross-section of a weave pattern used in one embodiment of the filtration belt;

FIG. 6 illustrates the cake and non-cake sides of a filtration belt of FIG. 1;

FIGS. 7a and 7b illustrate the edges of the filtration belt in cross-section;

FIG. 8 shows the warp pull-out strength as a function of weave tightness and glue presence;

FIG. 9 shows a portion of an electrical transfer zone of a further embodiment of a filtration belt;

FIG. 10 shows a portion of an electrical transfer zone of a further embodiment of the filtration belt;

FIG. 11 shows a portion of an electrical transfer zone of a further embodiment of a filtration belt;

FIGS. 12A to E illustrate further designs for the electrical transfer zone;

FIG. 13 illustrates a belt filter press

FIG. 14 illustrates electrical transfer to the belts;

FIG. 15 illustrates the voltage gradient across the filtration belts;

FIG. 16 illustrates schematically the relative configuration of the belts and power supply with time in the presence of relative longitudinal drift of the filtration belts; and

FIG. 17 illustrates recirculation of filtrate within the belt press.

### DETAILED DESCRIPTION OF EMBODIMENTS

Electrokinetic technology can be used in belt filter presses which are usually deployed in harsh and challenging environments such as sewage treatment works, mines and industrial waste processing plants. An aspect of the invention described herein relates to woven belts which are able to provide effective hydraulic dewatering together with efficient and effective electrokinetic treatment. Woven materials provide excellent filtration media for hydraulic and electro-osmotic flow. In addition the woven belts are mechanically and chemically stable and robust and are adaptable to various different environments and substrate suspensions.

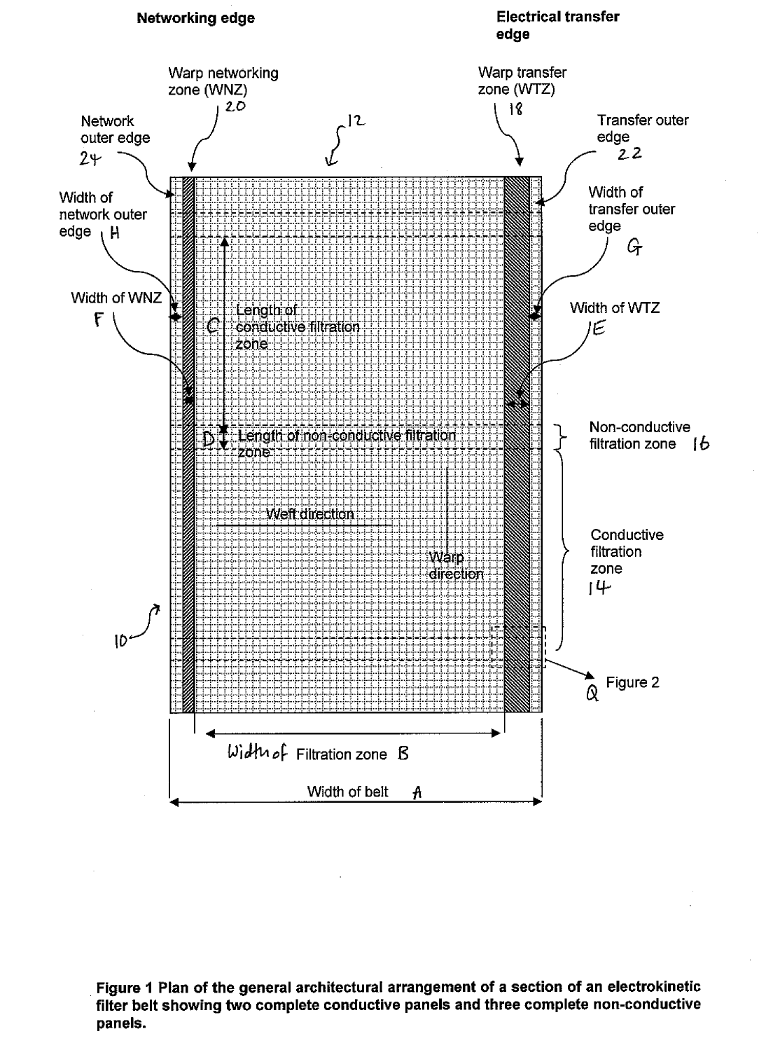

FIG. 1 illustrates an embodiment of a belt 10 for an electrokinetic belt press apparatus. The belt 10 comprises woven material consisting of a plurality of warp elements parallel to the longitudinal direction of the belt, and a plurality of weft elements transverse to the longitudinal direction of the belt. A central filtration zone 12 extends longitudinally along the belt 10. In FIG. 1, the belt has a width A, and the filtration zone has a width B. The filtration zone 12 includes one or more conducting zones 14 in which one or more weft elements comprise an electrically-conducting material. In this embodiment, these conducting weft elements are metallic. The warp elements of the filtration zone 12 are electrically-insulating.

The filtration zone 12 comprises a plurality of conducting zones 14 and non-conducting zones 16, alternately arranged along the length of the belt 10, wherein at least one weft element in each conducting zone 14 comprises an electrically-conducting material. In FIG. 1, the conducting zones 14 have length C and the non-conducting zones have length D.

The incorporation of conducting weft elements (e.g. metallic wefts) into the belts 10 increases cost and complexity of fabrication over that required for a standard belt and requires a range of specific structures within the belt to be developed to achieve effectively-focussed electrical transfer in a wet, dirty, dynamic environment.

In this embodiment, the warps are generally of a smaller diameter than the wefts and curve over and under the relatively straight wefts and thus crimp and hold the wefts in place. This effect can be further enhanced by the process of heat setting after weaving.

Herein, electrodes are defined as those parts of a circuit which represent the contact between metallic and non-metallic parts (in this case, sludge or similar material) of a circuit. The belt of the embodiment shown in FIG. 1 includes warp and weft elements or threads (referred to conveniently as warps and wefts), in which the warps are restricted to current distribution within the belt and are thus considered to be electrical elements, whereas the wefts discharge/collect electricity to/from the non-metallic parts of the circuit and are thus considered to be electrodes.

When considering belts as complex composite electrokinetic electrodes, there are several advantages to be secured by using wefts exclusively as the electrode elements with warps as exclusively the distributive electrical (non-electrode) elements. This arrangement insulates the belts from each other by preventing direct metal-metal contact if the belt press is operated without sludge or a less than full width bed of sludge. If direct electrical shorting were to occur then this would produce very high localised currents which would damage the belts and could even be a source of danger.

It has been found that current densities from the belts are typically 20-80 A/m² during normal operation i.e. when sludge is present. Further it has been found that this value quickly reduces to around 2-10 A/m² if the sludge feed is stopped and the applied voltage maintained. This was a surprising finding because it was expected that, as the belts came closer together due to the absence of sludge, the voltage gradient would increase and a large current would thus be expected. One reason for this drop of current density is that the under- and over-lapping warps enclose the wefts in a kind of cage such that when two belts come in to direct physical contact, it is the insulating warps which contact each other thus minimising direct contact between the conducting weft electrodes. In the majority of situations, the contact is ideally eliminated. A further reason for the drop of current density is that the non-conducting warps and wefts are made of polyester, which is hydrophobic, and which together with the primary filtration function of the belts serves to isolate the majority of the exposed surface of the metallic wefts on adjacent belts from each other.

Secondly, when running a belt press it is the electrodes which, being directly in contact with the sludge, predominantly undergo corrosion. Therefore, the use of weft elements, exclusively, as the electrodes and warp elements as distribution elements, means that current is only discharged from the wefts and there will therefore be no corrosion associated with the warps. If corrosion of wefts occurs, then the warps, which are situated on the outside surface of the belt, will maintain in full their crimping and structural stabilising function on the wefts. If the warps of the filtration zone were also metallic electrodes, in addition to the metallic electrode wefts, there would be several effects which would select warps for greater corrosion and accelerated mechanical and or electrical failure, including the following:

(i) When the belts are used as a pair in a belt press, the metallic electrode warps of the filtration zones of the two belts would be closer to each other than the wefts and thus the voltage gradient and subsequent current associated with the warp electrodes would be higher there than that associated with the wefts, i.e. the current would be disproportionately associated with the warps. This would mean current-associated corrosion would be concentrated on the warps, which being thinner to start with than the wefts would be at greater risk of breakage.
(ii) Weft elements enclosed with a ‘cage’ of warps would be surrounded by elements at exactly the same or a very closely matching electric field and thus the electrical field strength within such a cage would be very low and thus current discharge would be much reduced from the wefts. This would further concentrate current discharge to the warp elements with the consequences already described.
(iii) When the belt is running through a belt press apparatus, the warp elements are under much more stress than the weft elements because they lie parallel to the axis of tension that is acted through by the tensioning rollers, whose function is to tension the belts. It is known that corrosion occurs at an accelerated rate where metals are under a mechanical stress especially tensile stress. Increased stress would lead therefore to increased corrosion of metallic electrode warps.
(iv) Due to the way the belts pass through the apparatus the warp elements are constantly flexed in an alternating concave and convex manner relative the warp direction. Weft elements experience no such flexing. Flexing of this type, especially when under tension, can over time increase the fatiguing and micro crack propagation in materials. Therefore flexing and associated phenomena would lead to increased risk of corrosion of metallic electrode warps.

The combination of (i) to (iv) above together combine with another common feature, namely the use of smaller diameter warps (chosen to meet the required flexibility of warps), typically around 0.5 mm. This compares to a weft diameter of typically 0.7 mm (i.e. almost twice the quantity of material in the warp) and means that warps would be much more susceptible to mechanical failure than wefts. If a weft were to break it is of little consequence to the structural integrity of a belt in a belt press situation because, lying in the direction transverse to that of motion, the weft is not required to resist any significant stress. However if a warp were to break, then the load borne by that warp thread would then be transferred to neighbouring warps. If all the warps become weakened due to the combination of factors described, this situation could lead to a progressive failure affecting the whole width of the belt.

Thirdly, the use of only wefts as electrodes (and hence metallic) provides more options in the weaving process to increase the diameter of the wefts relative to the warps, whilst maintaining the same flexibility and filtration character of the belts. Such an option is not available for metallic warps.

Fourthly, the use of weft-only electrodes makes it possible, in conjunction with the invention of the electrical transfer zone (also referred to as a warp transfer strip, warp transfer zone or WTZ) described below to create discrete conductive zones in the belt with no mechanical interruptions and in a single weaving step. This produces a strong structure which is fit for purpose and cost effective to produce.

Fifthly, weft-only electrodes allow the density of electrodes to be varied (e.g. from 1:1 to 1:5) on a continuous basis and thus the performance and cost of a belt to be adapted to different technical and economic situations and opportunities.

Sixthly, if the weft elements should become gradually thinned during service due to corrosion, then the tension applied by the tension rollers and directed in the warp direction would serve to tighten the warps onto the thinned wefts and thus maintain the integrity and filtration performance of the belt.

Referring again to FIG. 1, the central filtration zone 12, which retains sludge material during passage through a belt press apparatus, is bordered on one side by an electrical transfer zone 18 (also referred to as a warp transfer zone (WTZ)) and on the other by an electrical network zone 20 (also referred to as a warp network zone (WNZ)), leaving a narrow strip of material on the outer side of each: the transfer outer edge 22, of width G, and the network outer edge 24, of width H, respectively.

The electrical transfer zone 18 includes conducting warp elements in contact with the weft electrodes of the filtration zone 12. These conducting warp elements are partly exposed at the surface of the belt 10 as they under- and over-lap the wefts, so that connection to a power supply can be established by means of contact brushes. The electrical transfer zone 18 provides an effective means for distributing electricity from a power supply to the weft electrodes.

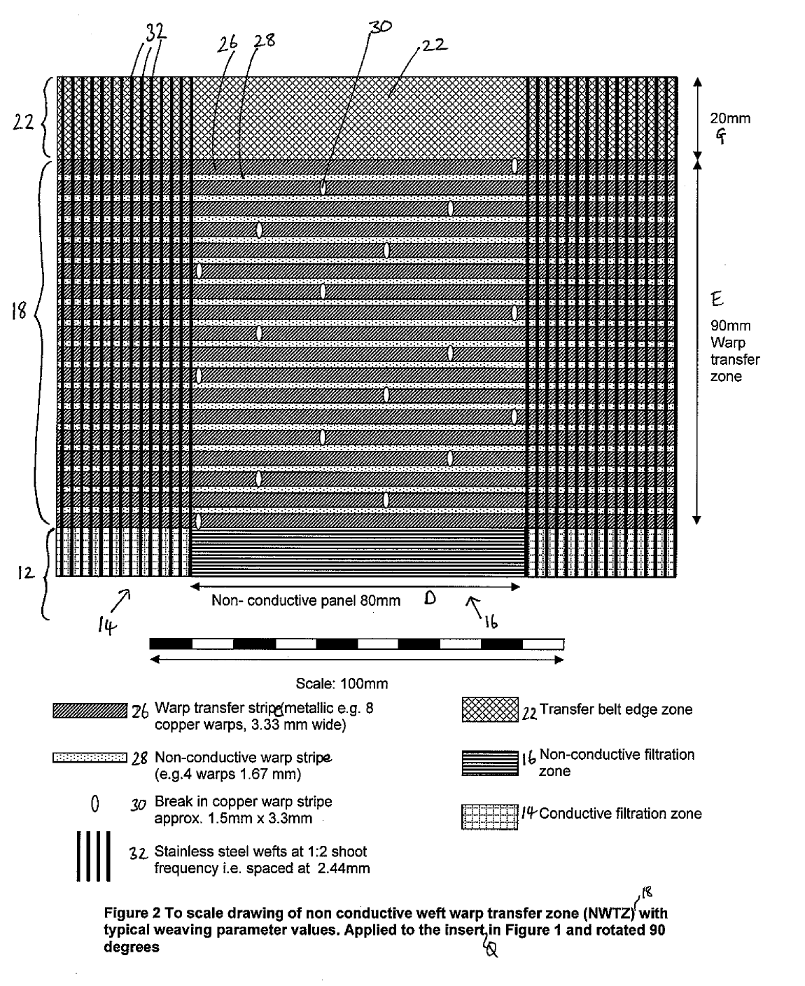

The belt 10 is split longitudinally into alternate conducting sections or zones 14 and non-conducting sections or zones 16. FIG. 1 illustrates a section of belt 10 comprising two complete conducting zones 14 and three complete non-conducting zones 16. Within the non-conducting zone 16 any weft threads are formed of a non-conductive material. Breaks or discontinuities 30 (see FIG. 2) are introduced into the electrical transfer zone 18 and electrical network zone 20 in order to isolate the discrete conducting zones 14, the discontinuities usually occurring adjacent a non-conducting zone 16.

An embodiment of an electrical transfer zone 18 is shown in more detail in FIG. 2. FIG. 2 illustrates a portion of the electrical transfer zone 18 adjacent to a non-conducting zone 16 of the filtration zone 12, indicated by Q in FIG. 1 and rotated by 90 degrees with respect to FIG. 1. (Such a portion of the electrical transfer zone may also be referred to as a “non-conducting-weft warp transfer zone (NWTZ)”.) Both the electrical transfer zone (WTZ) 18 and the electrical network zone (WNZ) 20 are achieved by the use and distribution of the same structures, and comprise closely spaced alternating conducting strips or stripes 26 of conducting metallic warp elements and insulating stripes 28 of insulating, non-metallic warps which together make up the electrical transfer zone 18. The conducting stripes 26 may each, for example, comprise 8 copper warps and have a width of 3.33 mm. The insulating stripes 28 may, for example, comprise 4 warps and have a width of 1.67 mm. The weft electrodes 32 of FIG. 2 are stainless steel and have a 1:2 shoot frequency (that is, every other weft is a conducting weft electrode) and are spaced at 2.44 mm. The metallic warps of the conducting stripes 26 are typically of a larger diameter (0.5-0.8 mm) compared to the non-metallic warps of the insulating stripes 28 (0.4-0.6 mm), although they can have the same diameter. The metallic warps having a larger size means that, when woven, the metallic warps stand proud of the non-metallic warps and thus provide an electrical contact surface for transfer brushes to contact. Because the electrical transfer zone 18 is outside the filtration zone 12 (FIG. 1) these warps do not play a role in filtration and thus the effect of the larger warps on filtration performance is irrelevant.

In use the metallic warps of the conducting stripes 26 collect/discharge electricity from/to electrical transfer brushes which provide an electrical contact connection between the belts and a power supply, and distribute the electricity across the metallic weft electrodes 32 of the conducting zones 14.

As shown in FIG. 2, the conducting stripes 26 contain breaks or discontinuities 30. The discontinuities 30 are located adjacent the non-conducting zones 16 of the filtration zone 12 to assist in the electrical isolation of neighbouring conducting zones 14. The discontinuities or breaks 30 are localised warp removal spots or loci. These may be formed by severing and removing short sections of the warp elements of the conducting stripes 26 (leaving the wefts intact) or by punching or perforating the conducting stripes (which typically removes portions of both warp and weft elements).

The insulating stripes 28, comprising non-metallic warps, electrically isolate the conducting stripes 26 from each other adjacent the non-conducting sections 16 of the filtration zone 12, since there are no metallic wefts in these regions. In addition, the non-metallic warps of the insulating stripes 28 provide mechanical stability to the belt 10 in the warp direction in locations adjacent to breaks 30 in the metallic warps of the conducting stripes 26.

In arranging the electrical transfer zone 18 as an array of narrow stripes 26, 28 parallel to the warp direction, neighbouring conducting stripes 26 are isolated from each other in the weft direction adjacent the non-conductive zones 16 of the filtration zone 12. In addition, an effectively continuous surface for electrical transfer is obtained. The narrow width of the conducting stripes 28 also ensures that breaks in the metallic warps of these stripes 28 result in apertures of small dimensions (typically 1.5×3 mm to 3×15 mm).

Moreover the overall stiffness of the electrical transfer zone 18 is reduced so that there is a manageable differential strain between the main part of the belt and its edges.

The reason for locating breaks 30 in the conducting stripes 26 adjacent to the non-conducting zone 16 of the filtration zone 12 is to electrically isolate neighbouring portions of conducting stripes 26 that contain breaks 30. This is achieved because weft-parallel electrical connection is prevented due to the absence of metallic wefts in the non-conductive zones 16 (FIG. 2). Moreover the non metallic wefts in the non-conductive zones 16 act to mechanically stabilise the belt 10 where the metallic warps of the conducting stripes 26 contain breaks or s.

The breaks 30 in the conducting stripes 26 are located in the non-conducting zones 16 in order to achieve electrical isolation of neighbouring conducting zones 14. It has been found that, as the belts are under constant tension during use, the breaks 30 in the conductive stripes 26 must be spatially distributed in order to minimise stress concentrations and thus avoid unacceptable strain or even rupture of the woven structure. The breaks 30, especially in neighbouring conducting stripes 26 are therefore arranged so that they are located at a distance from each other in the longitudinal direction of the belt 10, so as to invoke the friction associated with crimping of weft yarns (which is proportional to the number of wefts bound by the warps in question), and which may also be enhanced by impregnated insulation. Because the discontinuities 30 in neighbouring conducting stripes 26 of the electrical transfer zone 18 are longitudinally displaced from each other, the breaks 30 do not line up across the width of the electrical transfer zone 18 so as to create a zone of preferential weakness which might otherwise cause a critical failure of the mechanical integrity of the belts.

The pattern of the breaks (e.g. perforations) 30 in the conducting stripes 26 of the electrical transfer zone 18, that is their location, distribution, size and number, is critical to maintaining stability. There are several competing factors influencing the pattern which can be summarised as follows:

1. Each and every conducting stripe 26 (wherein a conducting stripe 26 is defined as a group or bundle of preferably two or more conducting warps) must have at least one break 30 within the non conductive zone 16.
2. The length of each break 30 in the warp direction (longitudinal direction) must be large enough to ensure electrical isolation of the conducting stripe 26 across the break 30. This will be enhanced by the subsequent impregnation with polyurethane or similar glue.
3. The width of the breaks 30 in the weft direction should ideally be large enough to create a break in all the metallic warps of a given stripe 26 but should not create (or should at least minimise) collateral damage of adjacent non-metallic warps.
4. Breaks 30 must be distributed across the electrical transfer zone 18 (and similarly, the electrical network zone 20) of the non-conductive sections 16 so as to minimise stress concentrations and maximise stability when under tension in service.
5. The distribution of breaks 30 should be designed so as to maximise the ease of production of the belt 10 but also to maximise stability of the belt 10.
6. The overall length of the non-conductive filtration zone 16 should be minimised in order to maximise the electrokinetically effective areas (i.e. the conducting zones 14 of the filtration zone 12) and yet permit the portions of the electrical transfer/network zones 18, 20 of the non-conducting sections 16 of the filtration zone 12 to be long enough to contain the breaks 30 in a mechanically stable distribution.

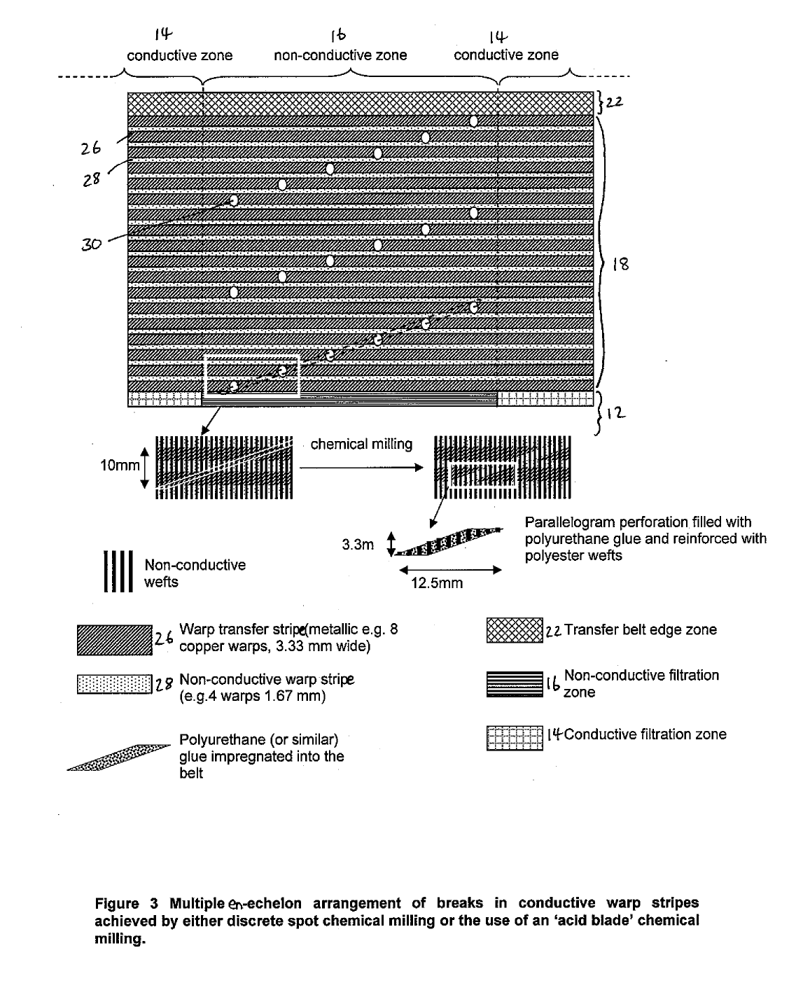

The en echelon distributions or patterns of the breaks 30 shown in FIGS. 2 and 3 illustrate the basic need for breaks 30 in adjacent stripes 26 to have minimal effect on one another. Creating a break 30 in a warp or warp stripe reduces the strength of the warp(s) in that region.

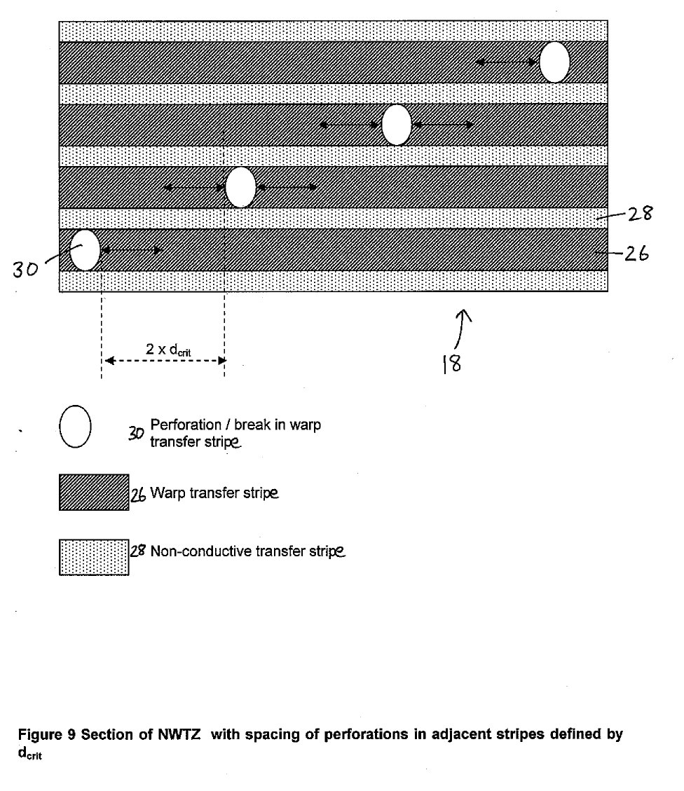

FIG. 8 represents a relationship between the stress required to remove (pull out) a single warp in a woven belt which contains a break 30 in the form of a perforation, as a function of distance from the perforation 30. The pull-out strength reduces the closer the locus of attachment is to the perforation 30. As shown in FIG. 8, a tight weave increases the friction, which resists pull-out due to the crimping action of the warps as they pass under and over the wefts. For the loose weave, pull-out strength is lower. The friction which resists pullout depends on a wide range of factors such as yarn type and dimensions, weave pattern and heat setting and the presence/absence of impregnated glue in the weave (such as is described below in relation to electrical isolation, encapsulation and stabilisation). At a certain critical distance from the perforation (located at distance d_{crit} in FIG. 8), the pull-out resistance of a perforated warp will be the same as the pull-out resistance of any other (perforated/non-perforated) warp, which represents yield and/or failure depending on the nature of the warp yarn. The value of d_{crit} varies from a few millimetres up to several tens of millimetres.

The continuous warps (in this case polyester yarns) of the non-conducting stripes 30 which are adjacent to the breaks 30 in the electrical transfer zone 18 and electrical network zone 20 will bear a higher stress than those located in the main part of the belt because of the inability of the metallic warps in the conducting stripes 26 to bear any stress (due to the breaks 30). As distance increases away from the breaks 30, the metallic warps of the conducting stripes 26 carry more stress owing to the gradually increasing friction associated with the crimping effect of the warp/weft interaction and the cumulative shear strength associated with the effects of the impregnated glue. At a distance of d_{crit} or greater, there is no longer a significant stress differential between the metallic warps of the conducting stripes 26 and the non-conducting polyester warps of neighbouring insulating stripes 28 in the electrical transfer zone 18 and electrical network zone 20.

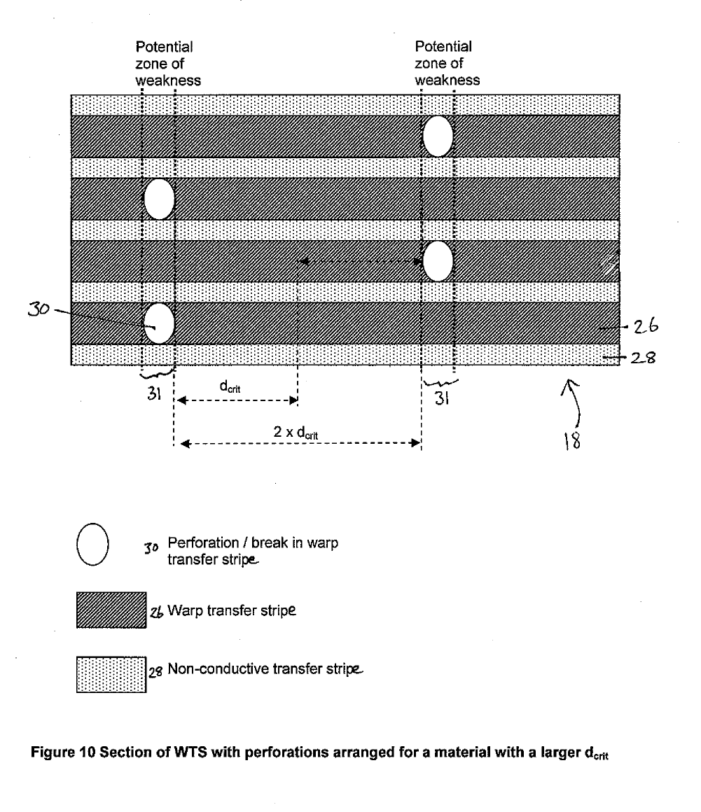

The distance d_{crit} is therefore useful for defining the relative stagger of the breaks 30 as shown in FIG. 9. FIG. 9 shows a section of the electrical transfer zone 18 in a non-conducting zone 16. These portions of the electrical transfer zone re also referred to as “non-conducting-weft warp transfer zones” or “NWTZ”. The corresponding portion of the electrical network zone 20 in the non-conducting zones 16 are similarly referred to as “non-conducting-weft warp network zones” or “NWNZ”.

From the above consideration of d_{crit}, the spacing of breaks 30 in adjacent conducting stripes 26 would be 2×d_{crit}, as shown in FIG. 9. It might be the case that, given the rough surface of the multifilament copper used for the warps of the conducting stripes 26, the effect of glue impregnation on friction would be even greater than that for a smooth polyester yarn. It might be considered that <100% of the d_{crit} value would be sufficient given the over-engineered design of belts, which are in general designed to meet filtration characteristics first rather than stress limits.

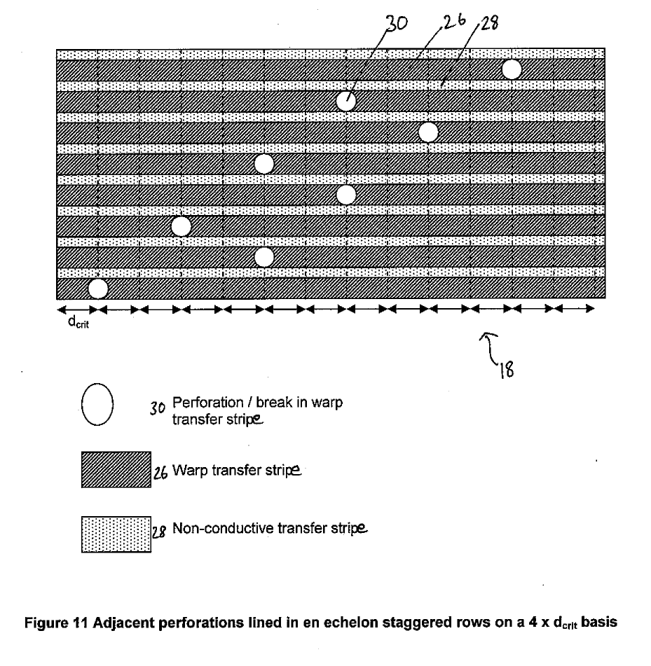

If it were determined or felt that d_{crit} was, or was likely to be quite large, then the longitudinal spacing of breaks 30 in adjacent conducting stripes 26 of the electrical transfer zone 18 or electrical network zone 20 would need to be greater. Nonetheless, all perforations 30 must fit within the portions of the electrical transfer zone 18 or electrical network zone 20 of the non-conducting zones 16, and it is desired to minimise the length of the non-conductive zones 16 of the filtration zone 12 in order to minimise the occurrence of non-electrified sludge. In the case of d_{crit} being relatively large, the spacing between breaks 30 in adjacent conducting stripes 26 might be increased as shown in FIG. 10. FIG. 10 shows a section of an electrical transfer zone (warp transfer zone WTS) 18, with perforations 30 arranged for a material having a larger d_{crit} than that shown FIG. 9. In FIG. 10, a double echelon pattern is used so that the pattern of perforations 30 occupies a similar length of the electrical transfer zone 18 as in FIG. 9. However, some of perforations 30 line up across the width of the electrical transfer zone 18, which may result in a zone of weakness indicated by the zone 31 in FIG. 10.

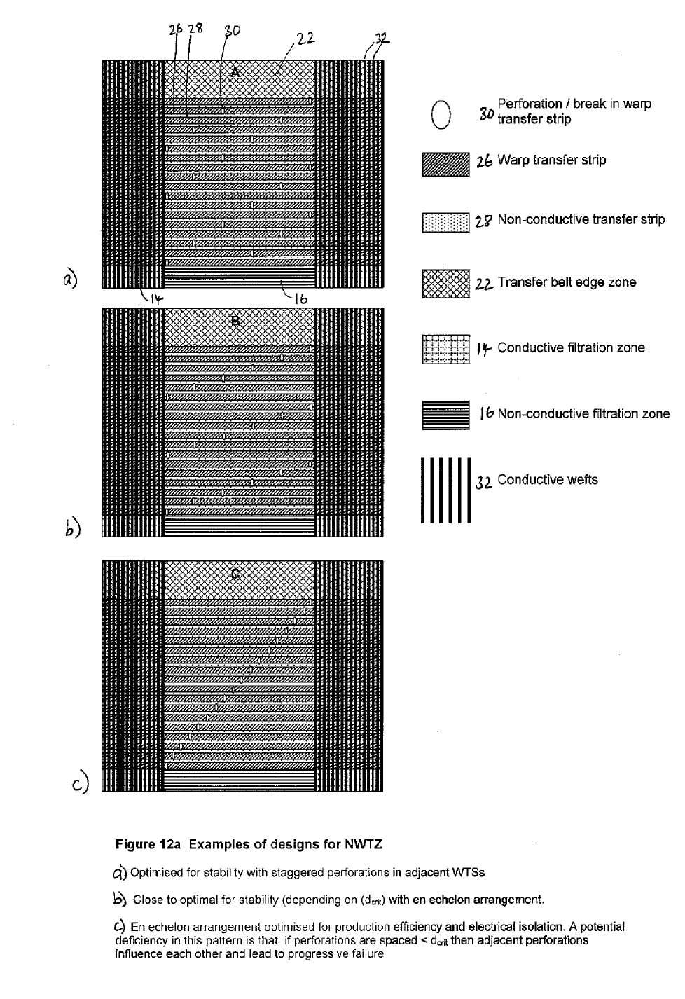

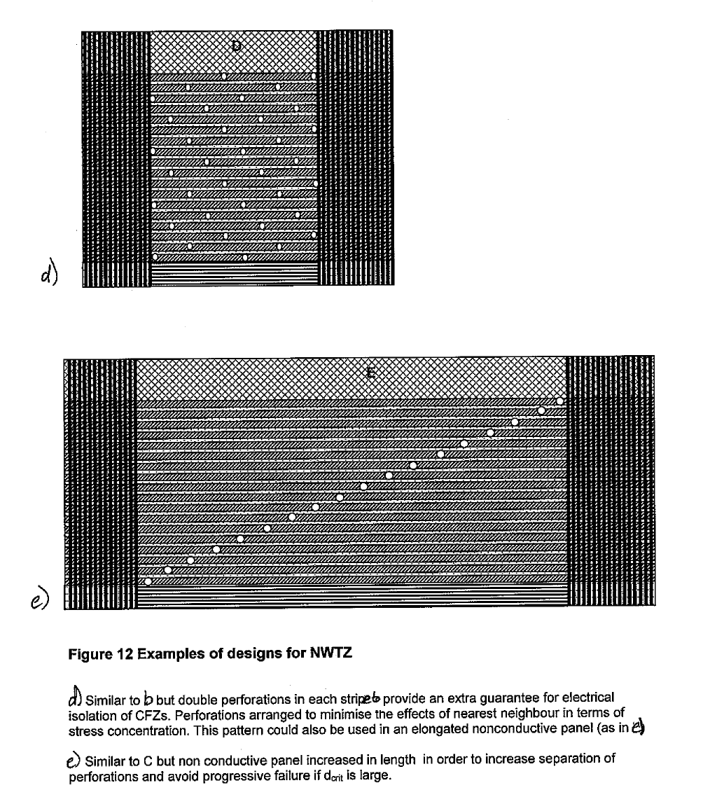

FIG. 11 shows a further example of the distribution of breaks 30, in which perforations 30 are distributed in en echelon staggered rows on a 4×d_{crit} basis. FIG. 12 shows five further examples of distributions of breaks 30. In FIG. 12(a), the pattern is optimised for stability by staggering perforations 30 in adjacent conducting stripes 26. In FIG. 12(b), the pattern is close to optimal for stability (depending on d_{crit}) with en echelon arrangement. FIG. 12(c) shows an en echelon arrangement optimised for production efficiency and electrical isolation. A potential deficiency in this pattern is that if perforations 30 are spaced by less than d_{crit} then adjacent perforations 30 influence each other and may lead to progressive failure. The pattern shown in FIG. 12(d) is similar to that of FIG. 12(b) but there are double perforations in each stripe to provide an extra guarantee of electrical isolation of the conducting zones 14. The perforations 30 are arranged to minimise the effects of nearest neighbour in terms of stress concentration. This pattern could also be used with an elongated non-conducting panel 16 as in FIG. 12(e). FIG. 12(e) is similar to FIG. 12(c) except that the non-conducting panel or zone 16 is increased in length in order to increase the separation of perforations 30 and thereby avoid progressive failure if d_{crit} is large.

As can be seen from FIGS. 2, 3 and 12, it is possible to arrange the breaks 30 so that they do not line up across the width of the electrical transfer zone 18, thereby distributing stress within the belt so that a zone of weakness is not created. It has been observed that large weft-parallel discontinuities cause critical failure of the mechanical integrity of the belts. The pattern of breaks 30 shown in FIG. 2 moreover minimises the overall length of the non-conductive zone which maximises the overall proportion of the complete belts which are composed of conductive zones and are thus electrokinetically active.

With reference to FIG. 3, methods of producing breaks 30 in the conducting stripes 26 will be described. The breaks 30 in the conducting stripes 26 can be achieved by severing and removing short sections of the warp elements in the conducting stripes 26. This can be done during the weaving process. The severed metallic warps may be replaced with plastic warps during the weaving process (which is a slow and costly method). Alternatively breaks 30 may be created in complete metallic warps by mechanical perforation, severing of individual warps or, more preferably through acid digestion, which is also known as etching or chemical milling. Typically the non-metallic yarns of filtration belts 10 are composed of polyester, which is resistant to strong acid. Other acid resistant yarns may also be chosen which are especially heat resistant and or have a higher tensile stiffness in order to blend stiffness moduli with the adjacent metallic warps e.g. polyamide or ‘kevlar’. Using chemical milling restricted to within the boundaries of non-conductive zones or panels 16 to remove discrete sections of conducting stripes 26 has two important functional effects.

Firstly, the non-metallic warps of the neighbouring insulating stripes 28 are left untouched, which would be difficult to guarantee with mechanical methods of creating breaks. Secondly, the wefts within the non-conducting zones 16, which are exclusively non-metallic, are also left untouched. These wefts subsequently play an important reinforcing role in stabilising the area of the breaks 30 in the conducting stripes 26.

Chemical milling can be achieved by spraying acid at spot locations, for example the pattern of breaks 30 in FIGS. 2 and 3. Improvements in speed and production efficiency can be achieved by using chemical milling in the form of an ‘acid blade’: in this instance the non-metallic wefts which cross the break in the chemically milled metallic warp stripes become especially important in achieving subsequent mechanical stability.

The dimensions of the conductive zones 14 and non-conductive zones 16 are carefully determined in order to fulfil several key requirements. Conductive zones 14 must be long enough to span adjacent electrical contact locations (as required by the geometry of the particular machine in question). However, said conductive zones 14 must not be so long as to result in electrokinetic treatment of the sludge in parts of the belt press machine where it is of lesser effectiveness i.e. near the proximal rollers of the parallel section.

The non-conductive zones 16 should be long enough that the breaks 30 in the conducting stripes 26 can be sufficiently well distributed or spaced to ensure mechanical stability. At the same time, the length (in the warp-parallel direction) of the non-conductive zones 16 should be minimised in order to minimise the proportion of the overall lengths of belts which is occupied by the non-conductive zones 16. For example, using conductive zones 14 of 1,800 mm length and non-conductive zones 16 of 150 mm length means that within every 1,800-2,100 mm of overlapping belts there is 300 mm of inactive belt surface. It has been found that using a belt of such dimensions resulted in one in every six or seven solids content tests in electrokinetic dewatering trials producing a low result. By reducing the length of the non-conductive zones 16 to approximately 80 mm, this proportion was reduced to one in twelve.

Nonetheless, the length of the non-conductive zones 16 should not be so small as to encourage electrical discharge from adjacent conductive zones 14 through the sludge i.e. such that the non-conductive zone 16 is too small to fulfil its function of electrical isolation.

A clipper seam (not illustrated) should be located in at least one non-conductive zone 16 because the clipper seam is metallic and is effectively like a metallic weft. Since the conductive breaks 30 in the non-conductive zone 16 are spread over a finite distance e.g. 80 mm, the clipper seam must be precisely located in one non-conductive zone 16 or more preferably there must be a non-conductive zone 16 either side of the clipper seam. This needs to be matched to the lengths of the belts required by a particular machine.

The length of the non-conductive zones 16 must be long enough to ensure that there is sufficient strength adjacent to the breaks 30 in the conducting stripes 26 to secure the staples of the clipper seam. With the above requirements in mind it has been found that typical longitudinal dimensions for a conductive zone 14 in currently typical apparatus are in the order of 1,800 mm and typical dimensions for a non-conductive zone 16 are of the order of 80 mm.

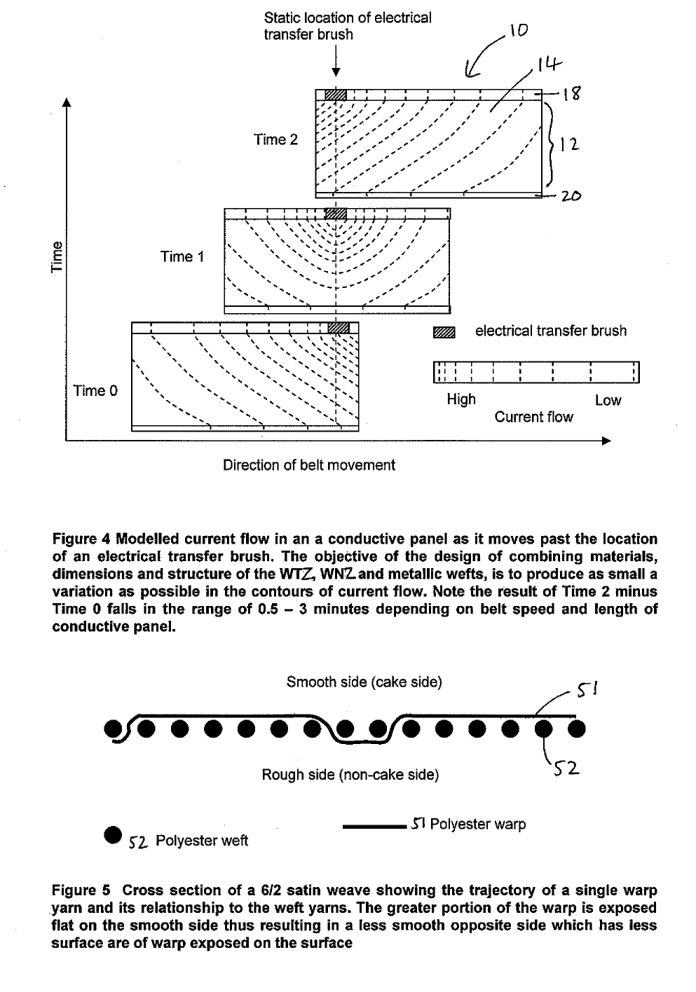

The current drawn through a conductive zone 14 is a function of several factors including the length of the conductive zone 14, the width of the belts 10, the expected electrical conductivity of the waste material to be dewatered, the thickness of material between the belts 10 and the anticipated operating voltage. This can be expressed in A/m² of belt electrode. For typical operating voltages in the range 15-20V, and typical cake thickness at discharge of 5-15 mm, current loads have been found to be in the range of 20-80 A/m² of belt. The conductive zone length, together with the width of the electrical transfer zone 18 and electrical network zone 20, is varied in order to distribute current throughout the conductive zone 14 without causing unacceptable voltage drops or resistive heating. It has been determined through calculation and experiment that the width of the electrical transfer zone (WTZ) 18 should be in the range of 50-100 mm and the width of the electrical network zone (WNZ) 20 in the range 15-30 mm. The width of the electrical transfer zone 18 at any given weft cross-section has to be able to cope with a current demand which is dynamic with respect to one belt as shown in FIG. 4 and which exhibits non-regular variations over a period of several hours because of the gradual drift of the belts relative to each other. FIG. 4 shows modelled current flow in a conductive zone or panel 14 of a belt 10 as it moves past the location of an electrical transfer brush (contact brush) of the belt press apparatus. Regions of higher and lower current are shown as contours. An objective in designing the combination of materials, dimensions and structure of the electrical transfer and network zones 18, 20, and metallic wefts is to produce as small a variation as possible in the contours of current flow. Note that the difference between Time 2 and Time 0 falls in the range of 0.5 to 3 minutes depending on belt speed and length of the conducting zone 14.

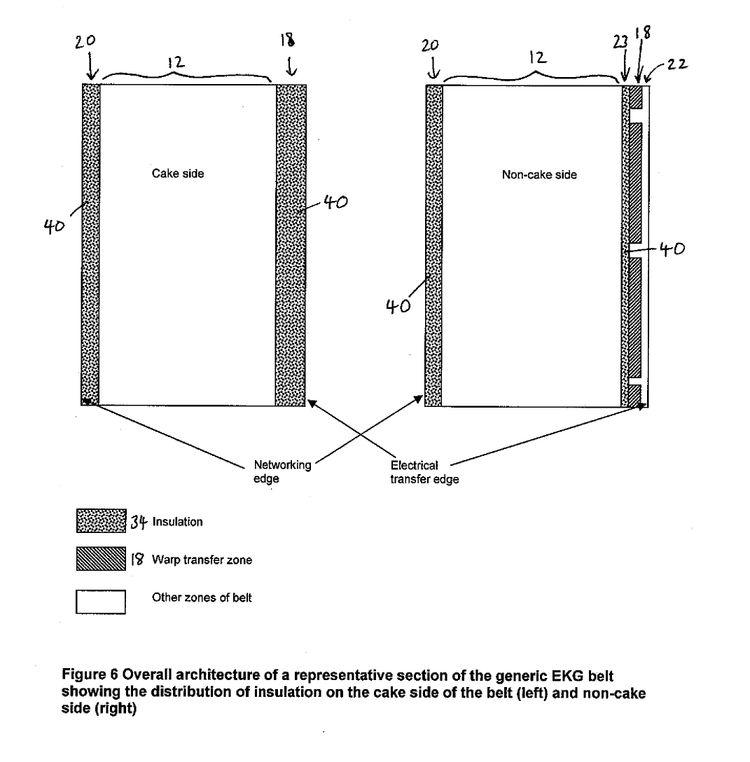

In order to achieve good cake discharge, the belts are produced with a smooth side and a rough side. Weaves exemplifying this difference include satin weaves. The consequence of having a smooth surface (created by adjacent warps) is that the rough surface (on the opposite side of the fabric or belt) has a concomitantly lower combined surface area of warp yarns exposed on the rough surface and that this surface itself is rough. Both effects are undesirable for electrical transfer. This effect can be achieved using the 6/2 satin weave shown in cross-section FIG. 5, in which the polyester warp threads 51 pass over six weft threads 52 and under two weft threads 52 before repeating this process. This produces a smoother surface on the side where six weft threads 52 are covered, which side can be used to support the sludge (or cake). The opposite side is less smooth as it has less surface area of warp 51 exposed on the surface. It will be appreciated that ratios other than 6:2 can be used to suit the use.

Whilst having a smooth cake side is good for filtration and detachment of dewatered cake from the belt 10, it means that the woven electrical transfer strip 18, which makes contact with the electrical transfer brushes by its being exposed on the non-cake side or rough side, has a rough surface texture and a reduced surface area for transfer of electrical current. For one aspect of the invention as described herein the satin weave is reversed in the vicinity of the electrical transfer strip 18 (this is not necessary for the electrical network strip 20) to provide a smooth surface for electrical pickup, the smooth surface including a high proportion of exposed metallic warps. This has advantages of reducing brush wear, reducing resistance and voltage drop and reducing localised current densities, which if too high can cause high temperatures and melting.

A further feature of the present invention is that the outer edges 22, 24 of the belt 10 are preferably woven using non-metallic warps. Although this feature reduces the overall area of the belts available for filtration, its inclusion does have advantages. Firstly, the woven edge physically separates the electrical transfer zone 18 of one belt 10 from the electrical network zone 20 of the other, where they come into close contact at the edge of the belts (and are commonly touching). Secondly, the weaving crimps the metallic wefts at the edge of the belt. Thirdly, a surface is provided into which a resin glue can be impregnated in order to provide insulation. Fourthly, being thermosetting in nature, the outer plastic warps fuse and seal the edges of the belt during post-weaving processing. It has been found that a width of the transfer and networking outer edge strips 22, 24 of approximately 20 mm is sufficient to fulfil the above functions whilst only reducing effective filtration area by 2%.

The architecture of the belt 10 requires two distinct types of conductive element. These are firstly weft elements whose primary functions is to act as a group of electrodes which discharge electricity to the material being dewatered (e.g. sludge) and secondly warp elements whose primary function is to conduct electricity between a moving contact with the electrical transfer brushes and the weft element electrodes. It is important that the materials and design of the warp and weft elements are chosen so that they can fulfil their primary functions and at the same time fall within certain limits relating to other physical constraints such as flexibility and strength and dimensions for weaving, crease retention of the finished fabric, electrical resistivity, thermal conductivity, smoothness when fabricated into the WTZ, passive corrosion resistance, corrosion rates under impressed current, ability to form a patina, conductivity of oxides; and a non-physical restraint: cost.

The structural options considered in the present invention are multi or mono-filament. In general, braided multi-filaments are less stiff and easier to handle than monofilaments of the same diameter. This makes them easier to weave (in wire gauges that belts are produced at) and when produced, a belt is less likely to hold a crease when produced with multifilament wires.

Although multi-filaments have a rougher surface in themselves when compared to mono-filaments, their greater overall flexibility results in a smoother surface on a weave when used in the running surface of the electrical transfer zone 18. This may be adjusted and trimmed however by the choice of satin weave. Thus multifilament or monofilament threads may be chosen on the basis of the smoothness of the satin weave required.

In addition, multi-filaments have a lower electrical resistance than monofilaments (of the same diameter). However, multi-filaments also have a higher surface area for current discharge which leads to a much higher surface area to volume ratio for potential corrosion and caking by reaction products (especially at the cathode). When a corrosion resistant coating such as mixed metal oxide is used, it has been found that the greater surface texture of a multifilament wire aids the adhesion of the coating to the surface. In this instance, a multifilament wire would therefore be used in the weft elements (which are the main discharge contact with the sludge).

It has been further found that advantageously, multi-filaments should be used in the warp and monofilaments in the weft. Production and trialling of belts shows that certain weaves, such as satin weaves, would benefit from mono-filament in the warp, whereas twill weaves always produce a rougher surface when using monofilaments compared to multi-filaments of an equivalent diameter and composition.

The physical constraints mentioned above apply differently to warp and weft from the point of view of both in-service functionality and production including weaving and post weaving or finishing processes. Multifilament copper is selected as the material which has a high enough electrical and thermal conductivity in order to lower the width of the electrical transfer zone 18 required to distribute anticipated current loads to the conductive zones 14, without taking up too much space which would otherwise be used for filtration.

In addition, multifilament copper has the advantage of being able to build up a protective patina from interaction with the electrical transfer brushes in the presence of heat and moisture. Moreover its oxide is electrically conductive, it is soft and flexible for the purposes of weaving and is readily soluble in acids for the purpose of chemical milling.

In environments where ammonia is present in large amounts copper can come under chemical attack and therefore other materials such as bronze alloys of copper may be used as a substitute. If stainless steel is chosen, the electrical design would need to be changed to accommodate, for example, the increased width of electrical transfer and network zones 18, 20. However such a substitution would reduce slightly the overall effectiveness and efficiency of the electrokinetic system.

As indicated above, the fundamental component of the electrokinetic belt 10 is a woven structure containing conducting (e.g. metallic) wefts which act as groups of electrodes, which discharge/collect current to/from the material being dewatered. Different weave styles and patterns appropriate to filtering and dewatering materials of different character are common in the art. However, the spacing of metallic wefts is of importance, depending on the use of the belt.

There are three key factors that influence weft spacing: (i) electric field shape between the belts, (ii) fineness or coarseness of weave and (iii) cost. In mining applications there is a tendency to run thicker cake between the belts compared to sewage applications. With a given spacing of conductive wefts there is less opportunity for cylindrical aberration of the electric field distribution between the belts when running a thicker cake compared to a thinner cake, therefore thicker cakes could make use of greater conductive weft spacing. Such aberrations reduce performance. With respect to weave tightness, the weave in mining might often be finer owing to the claylike and silty nature of the particles. A belt weave which might retain sufficient solids for sewage sludge applications could easily be too coarse for mine tailings and the material would pass through the belt resulting in inefficient filtration, high turbidity filtrate and caking of machine rollers. The varying of weft spacing allows the accommodation of (i) variations in cake thickness and electric field shape (ii) variations in weave. These impact on cost and can be optimised against electro-osmotic performance.

The woven structure of the belts allows frequency (and thus spacing) of the conducting (metallic) wefts to be varied: the minimum spacing corresponding to a frequency of 1:1 (i.e. every weft is metallic), the maximum being effectively 1:20. Typical ranges are 1:1-1:5. Varying the weft electrode density allows optimisation of several factors. A higher weft density means more linear electric fields with radial (cylindrical) distributions only occurring close to the surface of the belts. This results in fewer areas of effectively zero or very low electric field strength, with the concomitant effect on electro-osmotic flow. A higher weft density also provides a higher surface area for current discharge, which reduces localised corrosion rates and thus increases the lifetime of the belts. The higher surface area also facilitates electrolytic reactions and thus more even distribution of reaction products (including gases and dissolved ions). In turn the more dispersed distribution of electrolytic gases results in a reduced overall contact resistance between metal elements and sludge.

There is a possibility of reduced hydraulic filtration due to the capture of electrolytically produced gas bubbles forming menisci in the belts. This is especially a risk in belts with a fine weave compared to the more open weave and may be exacerbated in sludges which have a tendency to foam. This is potentially a greater problem with the cathode belt which (i) is the locus of the majority of drainage (both hydraulic and electro-osmotic) in the distal part of the parallel section of the belt press and (ii) produces double the volumetric quantity of gas compared to the anode belt.

The production of a higher weft density needs to be offset however against the advantages of a lower weft density whose production entails lower cost of raw materials, setting up and trimming, and which produces lighter belts which are more easily transportable. It has been found based on the above that optimum designs are: for an anode belt, a weft density of 1:1-1:2 and for a cathode belt 1:2-1:3. If the belts are to be interchangeable, then 1:2 is the optimum density.

A further feature of the belt 10 is the insulation encapsulation and stabilisation of the electrical transfer zone 18 and electrical network zone 20 near the edges of the belt 10. A component of the belt architecture is the impregnation detail at the edge. Along both edges of the belts, material in the form of a 2 pack glue, or 2 pack glue plus an adhesive strip, is applied. This provides electrical insulation, encapsulates metallic warps and wefts to prevent water or liquid ingress, and stabilises the warp and weft elements, particularly where breaks or perforations have been formed.

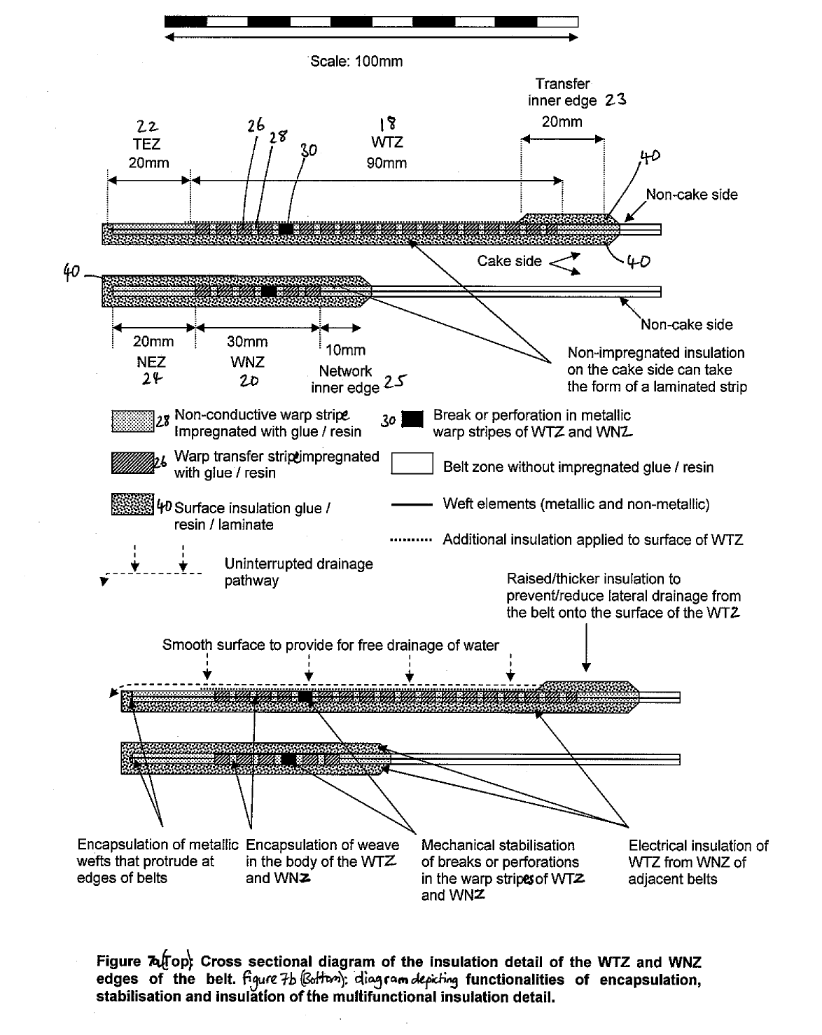

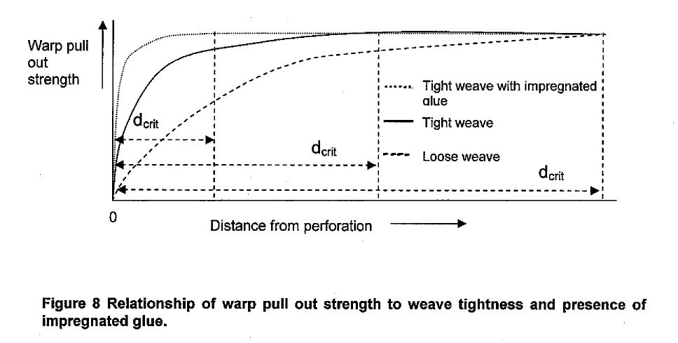

The general architecture of the multifunctional insulation detail is shown in FIG. 6, which shows the distribution of insulation on the cake side of the belt (left) and non-cake side (right). The detailed structure and functionality is shown in FIG. 7. FIG. 7a (top) is a cross-sectional diagram of the insulation detail of the electrical transfer/network zone 18, 20 edges of the belt. FIG. 7b (bottom) depicts the functionalities of encapsulation, stabilisation and insulation of the multifunctional insulation detail.

Insulation on the belt edges comprises impregnated two pack polyurethane (or similar) which is flooded into the belt across the entire width of the electrical transfer zone 18 and inner and outer transfer edges 22, 23. This impregnated material has the effects of encapsulating the warps of the electrical transfer zone 18 in both conductive and non-conductive zones 14, 16 so that they are not bathed in liquid of the material being dewatered and as such do not discharge electricity directly to the material being dewatered.

Polyurethane glue or other can be impregnated into the belt weave in such a way as to provide preserve the exposed metallic surfaces of the conducting stripes 26 in the portions of the electrical transfer zone 18 adjacent to the conducting zones 14 of the filtration zone 12, but also to completely or near completely encapsulate the portions of the electrical transfer zone 18 which are adjacent the non-conducting zones 16 of the filtration zone 12, while at the same time preserving a smooth surface at the point of transition between these portions. Further measures to prevent such leakage have been found to include the application of a thin coating of tough flexible paint.

Encapsulating the warps and wefts of the electrical transfer zone 18 also keeps their contact points permanently free of water. Metallic warp and weft materials may have dissimilar electrode potentials. Therefore, to prevent corrosion and thus maintain good electrical contact (and thus reduce voltage drops or the possibility of broken circuits), it is advantageous to apply this encapsulation.

The breaks or perforations 30 in the conducting stripes 26 of the electrical transfer/network zones 18, 20 can also be stabilised by the impregnated insulation. Where such breaks 30 are achieved by chemical milling, the non-metallic wefts act as reinforcement to the infilling provided by the impregnation (FIG. 3).

General stabilisation and increase in friction of the weave (by adding shear resistance at the warp over weft crimp points) of the electrical transfer/network zones 18, 20 and inner and outer transfer and network edges can also be achieved by impregnated insulation. This provides additional strength to the belt fabric in the non-conductive zones 16, which contain the perforations of breaks 30 in the conducting stripes 26.

In addition to the impregnation described above, surface-applied insulation 40 can be used on the cake side of the belt 10 to provide electrical insulation from the electrical network zone 20 of the other belt. This can be applied as a two pack polyurethane glue or as an adhesive strip. This provides additional insulation over and above that which is provided by the cage effect of the warps enclosing the wefts. This is particularly important because the belts often come together in direct contact at their edges (thus forming a lenticular cavity in cross section) for extended periods of time.

On the electrical transfer zone 18 edge, surface applied insulation 40 on the non-cake sides of the belt can be omitted from the surface of the electrical transfer zone 18 in order to permit the exposure of the conducting stripes 26 for electrical transfer. Such insulation can also be omitted from the transfer outer edge 22 of the belt in order to:

a) permit free flow of water off the edge of the belt and thus discourage pooling of water on the surface of the electrical transfer zone 18 and
b) prevent electrical transfer brushes lifting off the surface of the electrical transfer zone 18 if the belt 10 should track so as to move brushes temporarily onto the transfer outer edge 22. Both effects are deleterious to effective electrical transfer between the brushes and the conducting stripes 26. It has been found that slight lifting of the brushes due to this effect can result in current surges resulting in damage to the electrical transfer zone 18. Surface applied insulation on the inner transfer edge may be applied somewhat more thickly than elsewhere in order to reduce or prevent water from flowing laterally across the belt and onto the electrical transfer zone 18.

Metallic weft elements that may protrude from the edges of the belts can also be encapsulated. Owing to shrinkage of non-metallic yarns such as polyester upon heat setting, metallic yarns may extend a little beyond the edge of the belts. As such they may provide pathways for electrical shorting to the adjacent belt or possibly to the machine. Encapsulation as described above will prevent this from occurring.

In summary, the weaving technology used in the belt 10 described above provides many different advantages. Weaving yields a means to insulate belts 10 from each other and to prevent direct electrical shorting even when the belts are in direct contact with each other because the weft elements which discharge the electricity are always enclosed within over- and under-lapping warps. In addition, weaving provides a porous and stable matrix or skeleton for further impregnating material to be applied which can act to insulate, encapsulate and stabilise sections of the belt. Excellent electrical distribution throughout the belt is provided by an electrical transfer zone 18, so that connectivity is built-in as part of the primary fabrication process. This ensures mechanical integrity and acceptable production costs. The ease with which charge can be transferred from a current source is also increased by the creation of an electrical transfer strip or surface, the smoothness of which during operation of the belt can be optimised in a single manufacturing step.

Weaving allows a variety of different patterns with different spacing, materials and sizes of elements to suit the needs of different substrates (e.g. electrical conductivity, abrasivity, particle size distribution) and/or different operational objectives (e.g. desired dewatering performance and desired throughput rate). The resultant belt is therefore produced more cost effectively and is more adaptable than prior art link/spiral belt design. In addition, weaving easily and cost effectively permits the creation of discrete conductive and non-conductive panels 14, 16, combinations of which are infinitely variable and can be achieved during weaving itself. Electrical isolation of the conducting zones 14 of the filtration zone 12 can be achieved, whilst at the same time achieving mechanical stability of the belts in service and using a method which is cost effective to manufacture. The belts described above allow longitudinal continuity of the warps of the filtration zone 12, place no constraints on the weaving patterns and help to minimise wastage of weaving materials.

The weaving and finishing techniques described herein permit the belts to be adapted for use in different machines and also provides for insulation of an applied electrical potential from parts of the belt press apparatus or dewatering cycle which would not benefit from the electrokinetic effects. In this way, use of the belts in a belt press apparatus provides savings in electrical power and control of electrochemical reactions.

Many of the components of the belts described herein have multiple functions relevant to both production and use of the belts. The belts are designed to expressly achieve such multifunctionality.

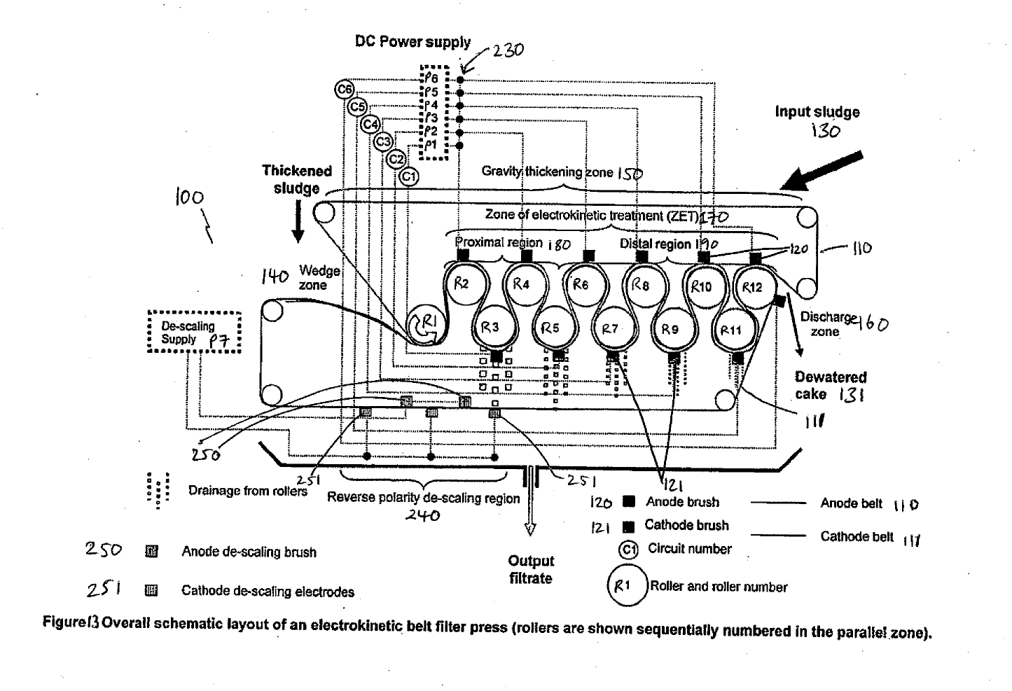

With reference to FIGS. 13 to 17, further aspects of the invention relating to a belt press apparatus and dewatering method will now be described. The belt press apparatus 100 shown in FIG. 13 incorporates the use of two endless filtration belts, 110, 111, each having electrically conducting portions, the belts 110, 111 acting together as a pair of electrodes to provide a dewatering force, in addition to hydraulic pressure, to remove water from an aqueous solid particulate suspension, e.g. sludge.

The aspects of the invention described below relate to methods of controlling electrical and hydraulic flow to maximise the performance and efficiency of the belt press system. The electrical control involves incorporating means to deal with the effects of changing sludge resistance, maintenance of an even electric field, accommodating axial relative belt drift and tackling build up of chemical precipitates. The hydraulic control involves methods, which improve electrokinetic dewatering.

The belts 110, 111 are preferably produced by weaving technology and are aimed at achieving a specific architectural arrangement of particular structural elements. In this embodiment, the belts 110, 111 are configured as the belt shown in FIG. 1, incorporating electrically conductive elements in the warp and weft directions together with other structures and features related to the weaving and post weaving preparation of the belts.

The use of these belts permits a very large number of combinations to be made of overall belt length, conductive zone length and non-conductive zone length, thus permitting the belts to be effective on any combination of belt press roller positions and diameters. However, the skilled person will appreciate that other belts may be used in the belt press apparatus described below.

FIG. 13 shows an electrokinetic belt press apparatus 100 for removing liquid from a material comprising a mixture of solid particles and liquid, the apparatus 100 comprising a first filtration belt 111 comprising a plurality of discrete, longitudinally-separated electrically-conducting areas, and a second filtration belt 110 comprising one or more electrically-conducting areas. A plurality of first contact elements 121, in the form of cathode contact brushes 121, are arranged to movably contact the first filtration belt 111. Second contact elements 120 (six in this embodiment), in the form of anode contact brushes 120, are arranged to movably contact the second filtration belt 110. Here, the contact elements slidably contact the belts, but the skilled person will appreciate that other arrangements are possible, for example the contact elements may roll along the belts, or be provided by conductive coatings or casings on the rollers R1-R12 of the belt press. Power supplies P1-P6 having independent output voltages are connected between a respective first contact element 121 and a respective second contact element 122, such that, in use, each conducting area of the first filtration belt 111 functions as a cathode when in electrical contact with one of the plurality of first contact elements 121, and each conducting area of the second filtration belt 110 functions as an anode when in electrical contact with one of the second contact elements 120.

The terminology and general configuration of the electrokinetic belt filter press apparatus 100 is shown in FIG. 13. The various zones of the belt press apparatus 100 referred to below relate to the positions of the two belts 110, 111 relative to each other, the electrical transfer locations 120, 121, sludge input 130 and sludge output 131. In use, the belts 110, 111 are conveyed around the belt press apparatus 100 by rollers R1 to R12. The zone, also referred to as the dewatering zone is the zone in which the belts 110, 111 come together and are separated by a thin layer of sludge, sandwiched between the two belts 110, 111 for the process of dewatering. The dewatering zone stretches from where the belts 110, 111 come together at roller R1 and where they peel apart at roller R12. In this zone, the belts are constrained to move approximately parallel to each other. Immediately preceding the dewatering zone is the wedge zone 140, which in turn follows from the gravity dewatering zone 150 (also referred to as the gravity thickening zone 150). Immediately following the dewatering zone is the discharge zone 160.

The zone of electrokinetic treatment (ZET) 170 falls within the parallel or dewatering zone. The length of this zone can be varied according to the different geometries of various belt filter press machines. It is defined in terms of a proximal region 180 and a distal region 190. The proximal region 180 is closest to the wedge zone 140 and thus the start of the dewatering zone, whereas the distal region 190 is closer the end of the dewatering zone and thus the discharge zone 160. The electrokinetic treatment zone (ZET) 170 is generally shorter than the dewatering section such that the electrokinetic treatment zone (ZET) 170 does not extend over the more proximal rollers of the dewatering zone i.e. rollers R1 and R2.

The belts 110, 111 comprise conductive zones (conducting zones 14 in FIG. 1) separated by non-conductive zones (non-conducting zones 16 in FIG. 1), which is referred to herein as conductive discretisation. The purpose of the discretisation is to control electric current within the zone of electro-osmosis and also to confine it to the electrokinetic treatment zone (ZET) 170. It has been found that the electrical resistance of the sludge between the belts 110, 111 increases towards the distal end of the dewatering zone. This means that although the thickness of the sludge cake (and thus the separation between the belts) is decreasing owing to dewatering and compression (and therefore the voltage gradient is increasing if a constant voltage is applied), the rate of thickness decrease is less significant than the rate of increase of the resistivity.

Therefore in order to maximise effectiveness of the system, it is important to have conductive discretisation of the belts because without this feature the proximal region 180 of the electrokinetic treatment zone (ZET) 170 would draw a current which is disproportionately large for its area. Further, this feature allows the applied voltage to be varied at different locations along the electrokinetic treatment zone (ZET) 170 to take advantage of the changing resistivity of the sludge and thus maximise dewatering effectiveness and efficiency. Moreover, the present invention also provides discretisation of the electrical power supply, by providing independent power sources, P1 to P6 (six shown in FIG. 13), and an equal number of DC circuits, C1 to C6, and pairs of electrical transfer locations 120, 121, comprising arrays of brushes.

It has been found that if circuits C1 to C6 are connected in parallel to a single power supply (i.e. without the discretisation described above and shown in FIG. 13), the current passing through the first circuit C1 reaches values up to 470 A compared to the 200 A maximum observed in that test for the other circuits, C2 to C6. Such a diversion of a current has several negative effects including:

(i) electrical energy is diverted away from the distal portion 190 of the electrokinetic treatment zone (ZET) 170, where electro-osmotic treatment has its greatest effects (because hydraulic drainage, as developed in a standard belt press, drops off sharply towards the distal end); and
(ii) the high current passing through the proximal portion 180 of the electrokinetic treatment zone 170 places extra demands (thermal mechanical and chemical) on the belts' brushes and cabling associated with the circuit.

The results of these effects are reduced effectiveness and efficiency of the electrokinetic treatment and reduced component life span. Circuits C2 and C3 are also affected by larger than expected currents, with the associated effects described. The size of the effect is not as great as for circuit C1

The present invention overcomes this problem by combining electrical discretisation (discrete conducting areas) of both the cathode and the anode belts 201, 202 with independent power sources (six shown in FIG. 13) and an equal number of DC circuits, C1 to C6, and pairs of electrical transfer locations or contact points 120, 121 (comprising arrays of brushes).

Importantly, this arrangement provides a separate power supply, or source of current, for each circuit C1 to C6, preventing current from being diverted to any one region. This arrangement further allows the voltage to be adjusted for each power supply, P1 to P6, independently. This usually means that for the same current, the voltage in the distal section 190 of the electrokinetic treatment zone (ZET) 170 can be higher than in the proximal section 180. It is the distal section 190 which derives the most benefits from electrokinetic dewatering because it is at this location where hydraulic dewatering is usually markedly less compared to the proximal section 180.

All materials (with the exception of superconductors) have electrical resistance. Electrical resistance causes a gradual reduction in the potential difference, which drives the current. The distribution of electrical contact points 120, 121 (comprised of arrays of brushes) is so arranged as to cancel out these reductions and thus maintain an even electric field across the sludge bed, which maximises overall electrokinetic treatment effectiveness and minimises hot spots and dead areas. Hot spots (regions of high current) can become sites of excessive wear, corrosion and fatigue.

In the belt press 100 shown in FIG. 13, the rollers R1 to R12 are shown arranged in two rows. Conveniently, the anode contact points 120 are arranged on the upper sides of rollers on one side of the machine (i.e. rollers R2, R4, R12 in the top row) and the cathode contact points 121 are arranged on the lower side of rollers on the opposite side of the machine (i.e. rollers R1, R3, . . . , R11 in the lower row). Alternating the anode and cathode contact points 120, 121 along the length of the belts in this way helps to maintain an even electric field along the length of the belts.

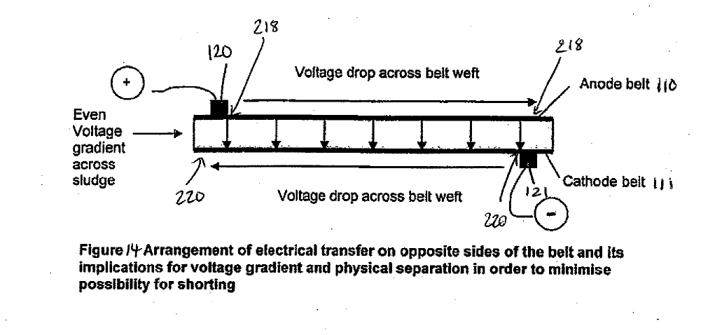

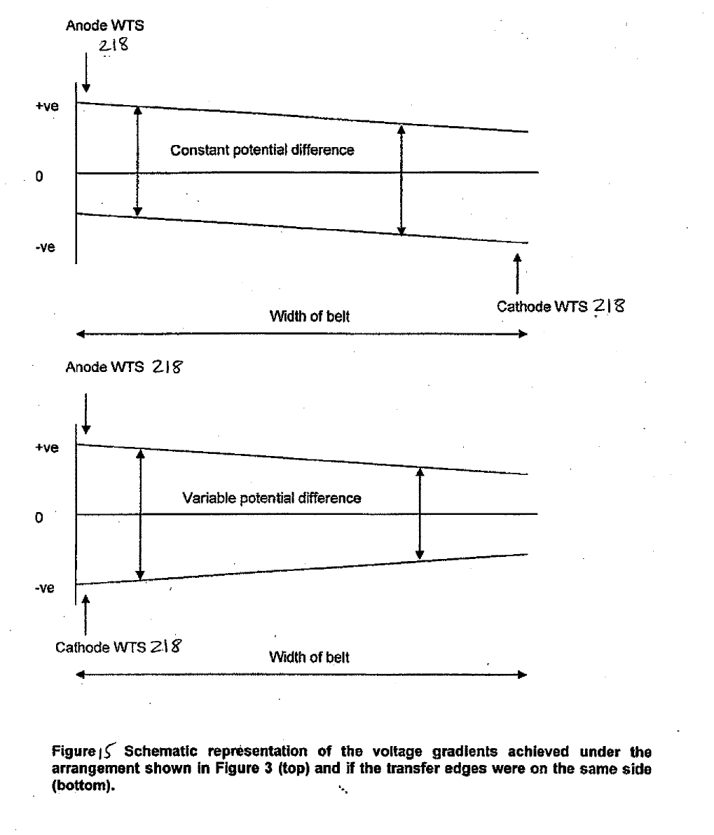

In addition, the anode and cathode contact points 120, 121 are arranged on opposite sides of the belts. This means that the belts are arranged so that the electrical transfer zone 218 of one belt is facing the electrical network zone 220 of the opposing belt. This arrangement of electrical transfer of opposite sides of the belts is shown in FIG. 14. This helps to maintain an even electric field across the width of the belts 110, 111, as it causes a cancellation of the voltage drops which occur along the metallic weft elements of both anode and cathode belts 110, 111. FIGS. 14 and 15 indicate the voltage drop which occurs from the electrical contact point (i.e. the electrical transfer zone 118) across the width of each belt. FIG. 15 illustrates the effect on the voltage gradient across each belt, and the resulting potential difference between the belts, of locating the anode and cathode contact points 120, 121 on opposite sides of the belts (FIG. 15a) rather than on the same side (FIG. 15b). Locating the anode and cathode contact points 120, 121 on opposite sides of the belt press apparatus results in a more uniform potential difference across the width of the belts. A further advantage of this arrangement is that the electrical transfer zone 218 of the cathode and anode belts 110, 111 are on opposite sides of the belts from each other and therefore the opportunity for electrical shorting is reduced. The exposed electrical transfer zone 218 of one belt is touching or very close to the completely encapsulated electrical network zone 220 of the opposite polarity belt, and thus there is no pathway for leakage of current.

The requirement to be able to control electrical parameters (current and voltage) within the electrokinetic treatment zone (ZET) 170 along which the sludge resistance changes, in order to confine electrical discharge to the electrokinetic treatment zone (ZET) 170 and to accommodate axial or longitudinal relative belt drift has been achieved in the present invention by the combination of a number of features. Firstly the belts are configured having discrete electrically conducting regions. Secondly, a plurality of separate DC power sources P1-P6 is provided: typically one DC power supply P1-P6 for each pair of anode/cathode contacts or brush locations 120, 121. Finally, one polarity of the separate DC power terminals is linked by a bus 230, or busbar.

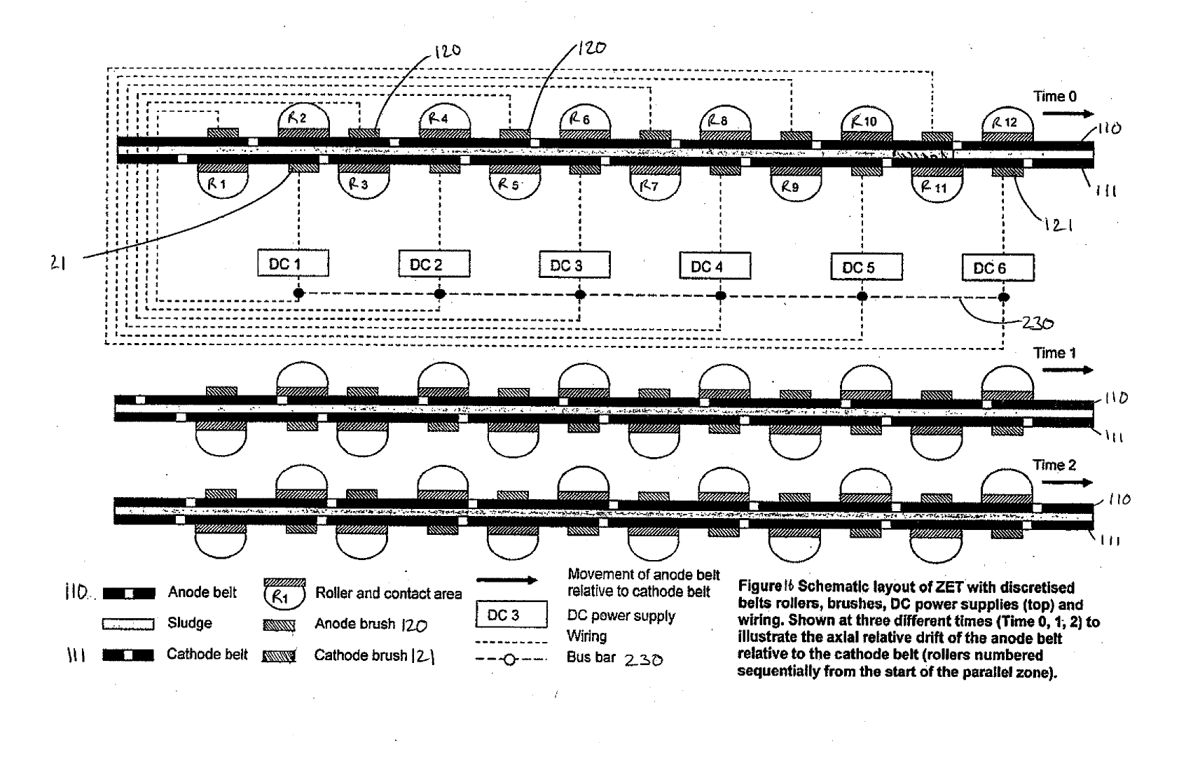

This arrangement is represented in FIG. 16, in which the sinuously-curved dewatering section of the belt press has been straightened out to aid interpretation. This shows the relative positions of the anode belt 110 and cathode belt 111 under conditions in which the anode belt 110 is advancing slightly with respect to the cathode belt 111. The belts 110, 111 are shown at three different times (time 0, time 1 and time 2). At each time, the conductive and non-conductive panels of the cathode belt 111 are in the same position relative to the layout of the brushes 120, 121 or contact points, but because of axial relative drift, the position of the conductive and non-conductive panels of the anode belt 110 are changing (i.e. advancing). It can be appreciated from comparing the three times shown in FIG. 16 that were it not for the anode busbar 230 which links the anode side of the DC power supplies DC1-DC6, then the relative overlap of conducting panels of the two belts would mean that the current drawn at the position of time 0 would be much less than at the position of time 2. However, owing to the addition of the busbar 230 linking all circuits C1-C6 on one side only, any one of the six DC power supplies DC1-DC6 can form a circuit with one conductive panel on the cathode belt 111 (excepting the occasional condition when the cathode brush 121 briefly contacts two adjacent panels simultaneously) and any two adjacent anode belt conductive panels. In this way the entire length of the electrokinetic treatment zone (ZET) 170 maintains full electrical discharge at all times, the power supplies DC1-DC6 remain independently controllable and there is no option for a disproportionately large component of the total current to be passed through the lowest resistance sludge at the proximal end 180 of the electrokinetic treatment zone (ZET) 170. Although both belts preferably comprise discrete conducting zones, it is possible for the belt which is electrically connect to the busbar 230 to comprise a single electrically conducting zone covering substantially the entire length of the belt.

In certain sludges and other materials the chemical composition of the sludge means that minerals such as struvite can be precipitated in the sludge transportation lines. Precipitation can be enhanced by a rise in pH and reduced by a drop in pH. Cases are known in the art where such mineral precipitates have been removed from surfaces such as the linings of pipes by the addition of medium strength acids e.g. 10% sulphuric acid. If such precipitates were built up within the cathode belt they would reduce the surface area available for current discharge/collection within the electrokinetic treatment zone (ZET) 170 and thus reduce the overall effectiveness of the electrokinetic treatment. Such build up could also reduce the ease of hydraulic flow through the belt which would affect overall dewatering effectiveness.

This effect may be counteracted by the employment of a localised section 240 of reverse polarity. This feature relies upon, and is made possible by the electrical discretisation of the belts. The location of the reverse polarity de-scaling zone 240 is shown in FIG. 13. In this zone 240 an anodic brush 250 contacts the electrical transfer zone 218 of the lower belt 111. The reverse polarity zone 240 is well outside of the electrokinetic treatment zone (ZET) 170 in which this lower belt 111 functions as a cathode. The corresponding cathodes 251 are formed from metallic elements embedded within non-metallic (usually nylon) support bars which traverse the width of the belt and serve to support the lower belt 111 (cathode belt) along the bottom of the machine on its travel from the cake discharge area 160 to the location where it rises to enter the wedge zone 140 where the two belts begin to come together before entering the parallel or dewatering zone. Thus for individual conductive panels in regular neighbour sequence and confined to one conductive panel at a time by their adjacent non-conductive panels, the conductive panels of the lower belt (cathode belt) 111 becomes anodic. That is, each conductive panel of the lower belt 111 becomes anodic in turn, one at a time, as the belt is conveyed through the belt press apparatus 100. This provides a regular, continuous, cleaning of the entire conductive surface of the cathode belt 111 and thus reduces the build up of chemical precipitates.

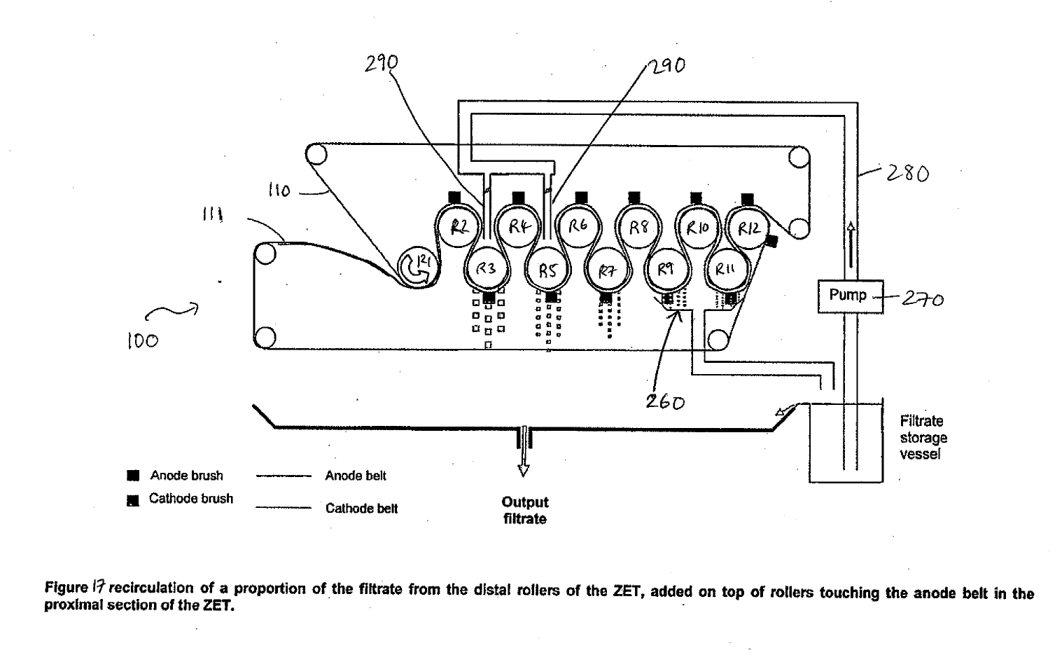

In conventional belt presses, the machine is always set up to prevent the filtrate produced by dewatering finding its way back into the sludge, which thus helps to ensure the maximum dewatering and cake dry solids content. This is why it is important to maintain a belt filter press in a clean condition and to ensure that all the drip trays are free draining. It has been surprisingly found that, by capturing water from the distal portion 190 of the electrokinetic treatment zone (ZET) 170 and recirculating it towards the proximal end 180 as shown in FIG. 17, benefits may be gained in terms of overall dewatering performance and corrosion reduction. FIG. 17 shows the belt press apparatus 100, collector 260 for collecting filtrate from the distal end 190 of the electrokinetic treatment zone 170, and a pump 270 and conduit 280 for returning the collected filtrate to the proximal end 180 of the electrokinetic treatment zone 170 via recharge nozzles 290.

It has been found that the filtrate from the distal rollers (e.g. rollers R9-R12) of the electrokinetic treatment zone (ZET) 170 has a higher pH than either the filtrate from the gravity thickening section 150 or the proximal section 180 of the electrokinetic treatment zone (ZET) 170. The high pH filtrate has a higher concentration of hydroxide (OH⁻) ions. This has several important benefits which can be exploited by recirculating a proportion of this filtrate water onto the anode belt 110 in the proximal section 180 of the electrokinetic treatment zone (ZET) 170. The improvement in dewatering performance can be rationalised into several chemical and surface-chemical effects associated with the hydroxide ions including the following. Firstly the electronegativity of the zeta potential of the solid-liquid interface in the sludge is reduced (becomes more negative), thereby maintaining a high coefficient of electroosmotic permeability, which would otherwise reduce gradually due to H+ ions produced by progressive electrolysis as the sludge moves through the electrokinetic treatment zone (ZET) 170. The correlation of lowering pH with reducing the electronegativity of the zeta potential (i.e. zeta potential becoming less negative) is well known in the art. In the great majority of cases, a reduction of the electronegativity of the zeta potential will also reduce the coefficient of electro-osmotic permeability and therefore electro-osmotic flow. Secondly, the increase in hydroxide ion concentration increases the chemical attack of cell wall material in the sludge, thus helping to break apart cells and release water for dewatering. Thirdly, acid production immediately adjacent to the anode elements is buffered, thus reducing the rate of corrosion of these elements. Finally, a slight reduction in viscosity and surface tension takes place. This improves the coefficients of electro-osmotic and hydraulic permeability and reduces meniscus forces thus aiding filtration.

The optimum rate of recirculation is related to a number of different factors that require calibration for each application. If too great a proportion of the filtrate collected from the distal rollers is recirculated, the overall quantity of water extracted from the sludge is reduced. If the proportion is too small, the effect is negligible. It has also been found that the location of the recharge nozzles 290 is important and can be varied to improve the effectiveness of the recirculation. Filtrate water is collected from the distal rollers (e.g. rollers R9-R12) because it is there that the filtrate water contains the greatest concentration of OH⁻ ions. This is then recirculated to the more proximal rollers on the lower level (e.g. rollers R1, R3, R5, R7). Ions in recharge water added close to the start of the parallel or dewatering zone (roller R1) have the longest time to take part in the chemical and surface chemical reactions identified. However, if the recharge water is added too close to the start of the dewatering zone and if the sludge being dewatered is particularly wet, the recirculated filtrate water can be quickly washed out with the filtrate. Therefore options are available to tailor the process to different machines with different numbers of rollers and sludges of different character. By way of example, only FIG. 17 is shown with recharge nozzles 604 located at rollers R3 and R5.

It will be appreciated by persons skilled in the art that the above embodiments have been described by way of example only, and not in any limitative sense, and that various alterations and modifications are possible without departure from the scope of the invention as defined by the appended claims.

1. A belt for an electrokinetic belt press apparatus for removing liquid from a material comprising a mixture of solid particles and liquid,
the belt comprising:
woven material including a plurality of warp elements substantially parallel to the longitudinal direction of the belt, and a plurality of weft elements transverse to the longitudinal direction of the belt;
a filtration zone extending longitudinally along the belt, wherein one or more weft elements of the filtration zone is electrically-conducting; and
an electrical transfer zone extending longitudinally along the belt between the filtration zone and a first edge of the belt, and comprising a plurality of electrically-conducting warp elements, wherein the or a plurality of said electrically-conducting weft elements is in electrical contact with at least one electrically-conducting warp element of the electrical transfer zone;
wherein the plurality of electrically-conducting warp elements of the electrical transfer zone are arranged as a plurality of substantially parallel stripes, each stripe comprising at least one electrically-conducting warp element, wherein adjacent stripes are separated from each other in the transverse direction by at least one electrically-insulating warp element.

2. A belt according to claim 1, wherein the warp elements of the filtration zone are electrically-insulating.

3. A belt according to claim 1, wherein the filtration zone comprises a plurality of conducting zones and non-conducting zones, alternately arranged along the length of the belt, wherein at least one weft element in each conducting zone is electrically-conducting.

4. A belt according to claim 3, wherein each electrically-conducting stripe of the electrical transfer zone is longitudinally discontinuous, each discontinuity being located adjacent a non-conducting zone of the filtration zone.

5. A belt as claimed in claim 4, wherein discontinuities in neighbouring electrically-conducting stripes are longitudinally displaced from each other.

6. A belt as claimed in claim 5, wherein the discontinuities are arranged in an echelon, V-shaped, zig-zag or saw-tooth pattern.

7. (canceled)

8. A belt as claimed in claim 1, wherein a plurality of said electrically-conducting warp elements of the electrical transfer zone have a diameter larger than the diameter of the or each electrically-insulating warp element of the electrical transfer zone.

9. (canceled)

10. A belt according to claim 1, wherein at least a part of the electrical transfer zone is impregnated with a synthetic resin.

11. A belt as claimed in claim 1, wherein the woven material of the electrical transfer zone of the belt is smoother on a first surface of the belt than on a second, opposite surface, wherein said first surface is adapted to contact terminals of an electrical power supply.

12. A belt as claimed in claim 11, wherein the woven material of the filtration zone of the belt is smoother on the second surface of the belt than on the first surface, wherein said second surface is adapted to contact the material to be dewatered.

13. A belt according to claim 1, further comprising an electrical network zone extending longitudinally along the belt and located between the filtration zone and a second edge of the belt, wherein one or more warp elements of the electrical network zone is electrically conducting.

14. An electrokinetic belt press apparatus for removing liquid from a material comprising a mixture of solid particles and liquid, comprising a belt as claimed in claim 1.

15. (canceled)

16. (canceled)

17. (canceled)

18. (canceled)

19. (canceled)

20. A belt for an electrokinetic belt press apparatus for removing liquid from a material comprising a mixture of solid particles and liquid, the belt comprising:
woven material including a plurality of warp elements substantially parallel to the longitudinal direction of the belt, a plurality of weft elements transverse to the longitudinal direction of the belt;
a filtration zone extending longitudinally along the belt, wherein one or more weft elements of the filtration zone comprise an electrically-conducting material; and
an electrical transfer zone extending longitudinally along the belt between the filtration zone and a first edge of the belt, and comprising a plurality of electrically-conducting warp elements, wherein the or a plurality of said electrically-conducting weft elements is in electrical contact with at least one electrically-conducting warp element of the electrical transfer zone;
wherein the woven material of the electrical transfer zone of the belt is smoother on a first surface of the belt than on a second, opposite surface, wherein said first surface is adapted to contact terminals of an electrical power supply.

21. A belt as claimed in claim 20, wherein the woven material in the filtration zone of the belt is smoother on the second surface of the belt than on the first surface, wherein said second surface is adapted to contact the material to be dewatered.

22. An electrokinetic belt press apparatus for removing liquid from a material comprising a mixture of solid particles and liquid, comprising a belt as claimed in claim 20.

23. An electrokinetic belt press apparatus for removing liquid from a material comprising a mixture of solid particles and liquid, the apparatus comprising:
a first filtration belt comprising a plurality of discrete, longitudinally-separated electrically-conducting zones, and a second filtration belt comprising one or more electrically-conducting zones;
a plurality of first contact elements, arranged to movably contact the first filtration belt;
one or more second contact elements, arranged to movably contact the second filtration belt; and
a plurality of power supplies, having independently determined output voltages,
wherein a plurality of said power supplies are connected between a respective first contact element and one of the or each second contact elements, such that, in use, a plurality of said conducting zones of the first filtration belt each functions as a respective one of an anode and a cathode when in electrical contact with one of the plurality of first contact elements, and the or a plurality of said conducting zones of the second filtration belt each functions as a respective other one of an anode and a cathode when in electrical contact with one of the or each second contact elements.

24. An electrokinetic belt press apparatus according to claim 23, wherein a spacing between neighbouring first contact elements is equal to or less than a length of the electrically-conducting zones of the first belt in the longitudinal direction.

25. An electrokinetic belt press apparatus according to claim 23, comprising a plurality of second contact elements, wherein a plurality of said power supplies are connected between a respective first contact element and a respective second contact element.

26. An electrokinetic belt press apparatus according to claim 25 , wherein said second belt comprises a plurality of discrete, longitudinally-separated electrically-conducting zones, and wherein a spacing between neighbouring second contact elements is equal to or less than a spacing between the discrete electrically-conducting zones of the second belt.

27. An electrokinetic belt press apparatus according to claim 25 wherein said plurality of second contact elements are electrically connected via a bus.

28. An electrokinetic belt according to claim 25, wherein a plurality of said first contact elements are arranged to movably contact the first filtration belt adjacent a first edge, and a plurality of said second contact elements are arranged to movably contact the second filtration belt adjacent an edge opposing a second edge of the first filtration belt.

29. An electrokinetic belt press apparatus according to claim 25, further comprising a plurality of rollers for conveying the first and second filtration belts through the dewatering section,
wherein said first and second contact elements are arranged to contact the first and second filtration belts adjacent alternate rollers.

30. (canceled)

31. (canceled)

32. (canceled)

33. (canceled)

34. (canceled)

35. (canceled)

36. (canceled)
